(19) United States
(12) Patent Application Publication
(10) Pub. No.: US 2001/0014870 A1
(43) Pub. Date: Aug. 16, 2001

(54) Electronic coupon sending and collecting scheme and information collecting and managing scheme using radio LAN

(75) Inventors: Takeshi Saito, Tokyo (JP); Yoshiaki Takabatake, Kanagawa (JP); Mikio Hashimoto, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/773,914

(22) Filed: Feb. 2, 2001

(30) Foreign Application Priority Data
Feb. 2, 2000 (JP) P2000-25473
Feb. 2, 2000 (JP) P2000-25474

(51) Int. Cl. G06F 17/60

(52) U.S. Cl. 705/14; 705/17

(57) ABSTRACT

An electronic coupon sending/collecting scheme that can be realized without utilizing communication providers is disclosed. In this scheme, an electronic coupon is sent from one radio base station provided in the facility to the radio portable terminal by using the radio LAN, either automatically or in response to a request for acquiring coupon made by the user. Then, the electronic coupon is collected from the radio portable terminal at that one radio base station or another radio base station provided in the facility by using the radio LAN, and a service corresponding to the electronic coupon is provided to the user of the radio portable terminal.

### BACKGROUND OF THE INVENTION

1. FIELD OF THE INVENTION

The present invention relates to an electronic coupon sending and collecting system and an information collecting and managing system to be provided and used at a store such as a convenience store or a supermarket.

2. DESCRIPTION OF THE BACKGROUND ART

In recent years, in conjunction with advances of the radio technology, communications between PCs using portable telephones and radio LAN are rapidly spreading. Currently major applications include those of telephone communications in a broad sense, Internet accesses, and office network applications used in the ordinary Ethernet LAN or the like.

On the other hand, the recent spread of portable telephones and PDAs (Personal Digital Assistants) virtually created a situation where “everyone has a terminal”, and in the future the enhancement of functions of such a portable terminal is expected. So far such a portable terminal having a radio communication function has been mainly used for (1) a public network communications (speech telephone communications, Internet accesses, etc.) via communication providers (communication carriers) and (2) communications (such as that for connecting a PC to a printer) between personal devices (or devices within some group).

In the future, in addition to these types of use, such a portable terminal is also expected to be used for (3) communications between a personal device and a business enterprise device, without utilizing communication providers. For example, for a store (such as a supermarket, a convenience store etc.) that is open to general public, an application for sending advertisement, discount coupons or various information to the portable terminal of a potential customer by using the radio communication function can be attractive.

However, in the current state of the art, a technology for realizing the above (3) has not been established yet, and there is no known mechanism for sending advertisement, coupons or various information to the portable terminal.

Namely, in the conventional electronic coupon system, it has been necessary to utilize the public communication line and to attach and detach a connector to a portable terminal of a customer in order to distribute or collect the electronic coupon to or from (a portable terminal of) a customer who is present inside the store, so that the conventional electronic coupon system has been associated with problems regarding its economical performance and convenience.

On the other hand, in recent years, the customer/market research using POS (Point-Of-Sale) register system is very popular at retail stores such as convenience stores, supermarkets, etc. This is an attempt to ascertain the so called “consumer trend” or “hit products” by recording information such as goods purchased by each customer and their prices into a database at a POS register and analyzing that information later on.

Meanwhile, discount coupons or service coupons have been conventionally used very often for the purpose of sales promotion at retail stores or the like, and there is a proposition to introduce electronic versions of these discount coupons and service coupons.

However, conventionally, it has been impossible to collect and analyze information regarding a movement pattern of each customer through various corners inside the store such as a convenience store or a supermarket.

Also, in the conventional POS register system, the database input is possible only at a POS register so that it has been impossible to analyze information such as “which user has purchased which goods” or even “which user has moved through which corners inside the store and purchased which goods from which corners”.

### SUMMARY OF THE INVENTION

It is therefore an object of the present invention to provide an electronic coupon sending and collecting scheme capable of sending and receiving various electronic coupons easily between a portable terminal of a user and a system of a business enterprise without utilizing communication providers.

It is another object of the present invention to provide an information collecting and managing scheme capable of enabling more detailed analysis of information regarding facility users such as customers.

According to one aspect of the present invention there is provided an electronic coupon sending/collecting method for sending/collecting an electronic coupon to/from a radio portable terminal by using a radio LAN, the method comprising the steps of: (a) requesting a notification of a terminal identifier of the radio portable terminal from a radio base station of the radio LAN to the radio portable terminal through the radio LAN; (b) receiving the notification of the terminal identifier of the radio portable terminal from the radio portable terminal at the radio base station through the radio LAN in response to the step (a); (c) requesting a check of whether the radio portable terminal of the terminal identifier notified by the step (b) is an electronic coupon sending/collecting target or not, from the radio base station to a server device; (d) checking whether the radio portable terminal of the terminal identifier notified by the step (b) is the electronic coupon sending/collecting target or not at the server device, and notifying a result of the check from the server device to the radio base station in response to the step (c); and (e) carrying out processing for sending/collecting the electronic coupon at the radio base station with respect to the radio portable terminal through the radio LAN, when the result of the check notified by the step (d) indicates that the radio portable terminal of the terminal identifier notified by the step (b) is the electronic coupon sending/collecting target.

According to another aspect of the present invention there is provided an electronic coupon sending/collecting system for sending/collecting an electronic coupon to/from a radio portable terminal by using a radio LAN, the system comprising: a radio base station of the radio LAN for carrying out communications with the radio portable terminal through the radio LAN; and a server device for managing information regarding the electronic coupon; wherein the radio base station has: a first communication unit configured to send a first request message requesting a notification of a terminal identifier of the radio portable terminal to the radio portable terminal through the radio LAN, and to receive a first response message notifying the terminal identifier of the radio portable terminal from the radio portable terminal through the radio LAN in response to the first request message; a second communication unit configured to send to the server device a second request message containing the terminal identifier notified by the first response message and requesting a check of whether the radio portable terminal of the terminal identifier notified by the first response message is an electronic coupon sending/collecting target or not, and to receive a second response message indicating a result of the check from the server device in response to the second request message; and a processing unit configured to carry out processing for sending/collecting the electronic coupon with respect to the radio portable terminal through the radio LAN, when the result of the check notified by the second response message indicates that the radio portable terminal of the terminal identifier notified by the first response message is the electronic coupon sending/collecting target; and the server device has: a communication unit configured to receive the second request message from the radio base station and to send the second response message to the radio base station in response to the second request message; and a coupon processing unit configured to check whether the radio portable terminal of the terminal identifier contained in the second request message is the electronic coupon sending/collecting target or not, and to produce the second response message indicating the result of the check.

According to another aspect of the present invention there is provided a radio base station device for sending/collecting an electronic coupon to/from a radio portable terminal by using the radio LAN, comprising: a first communication unit configured to send a first request message requesting a notification of a terminal identifier of the radio portable terminal to the radio portable terminal through the radio LAN, and to receive a first response message notifying the terminal identifier of the radio portable terminal from the radio portable terminal through the radio LAN in response to the first request message; a second communication unit configured to send to a server device a second request message containing the terminal identifier notified by the first response message and requesting a check of whether the radio portable terminal of the terminal identifier notified by the first response message is an electronic coupon sending/collecting target or not, and to receive a second response message indicating a result of the check from the server device in response to the second request message; and a processing unit configured to carry out processing for sending/collecting the electronic coupon with respect to the radio portable terminal through the radio LAN, when the result of the check notified by the second response message indicates that the radio portable terminal of the terminal identifier notified by the first response message is the electronic coupon sending/collecting target.

According to another aspect of the present invention there is provided a radio portable terminal device, comprising: a communication unit configured to carry out communications with a radio base station of a radio LAN provided in a store; a storage unit configured to store electronic coupons received from the radio base station through the radio LAN using the communication unit; a display unit for displaying display contents contained in each electronic coupon stored in the storage unit on a display screen; and a processing unit configured to carry out a processing for receiving any new electronic coupon issued by the store, a processing for using any stored electronic coupon that is usable at the store, and a processing for deleting any used electronic coupon from the storage unit, with respect to the radio base station through the radio LAN using the communication unit.

According to another aspect of the present invention there is provided a method for collecting and managing information on a movement of a user having a radio portable terminal in a facility where a plurality of radio base stations of a radio LAN are arranged at a plurality of locations inside the facility and the plurality of radio base stations are connected to a server device through a local network, the method comprising the steps of: (a) requesting a notification of a terminal identifier of the radio portable terminal that has moved into a covered area of each radio base station, from said each radio base station to the radio portable terminal through the radio LAN, and receiving the notification of the terminal identifier from the radio portable terminal at said each radio base station through the radio LAN; (b) notifying the terminal identifier notified at the step (a) from said each radio base station to the server device through the local network; and (c) recording and managing a management information containing the terminal identifier notified at the step (b) and information regarding an arranged location of said each radio base station which notified the terminal identifier at the step (b), at the server device.

According to another aspect of the present invention there is provided a system for collecting and managing information on a movement of a user having a radio portable terminal in a facility, the system comprising: a plurality of radio base stations of a radio LAN that are arranged at a plurality of locations inside the facility; and a server device connected to the plurality of radio base stations through a local network; wherein each radio base station has: a first communication unit configured to request a notification of a terminal identifier of the radio portable terminal that has moved into a covered area of said each radio base station to the radio portable terminal through the radio LAN, and to receive the notification of the terminal identifier from the radio portable terminal through the radio LAN; and a second communication unit configured to notify the terminal identifier received by the first communication unit, to the server device through the local network; and the server device has: a communication unit configured to receive a notification of the terminal identifier from each radio base station through the local network; and a management unit configured to record and manage a management information containing the terminal identifier received by the communication unit and a location information regarding an arranged location of said each radio base station that notified the terminal identifier received by the communication unit.

According to another aspect of the present invention there is provided a method for providing an electronic coupon service in a facility to a user of the facility who has a radio portable terminal by using a radio LAN provided in the facility, the method comprising the steps of: sending an electronic coupon from one radio base station provided in the facility to the radio portable terminal by using the radio LAN, in response to a request for acquiring coupon made by the user; and collecting the electronic coupon from the radio portable terminal at the one radio base station or another radio base station provided in the facility by using the radio LAN, and providing a service corresponding to the electronic coupon to the user, in response to a request for using acquired coupon made by the user.

According to another aspect of the present invention there is provided a method for providing an electronic coupon service in a facility to a user of the facility who has a radio portable terminal by using a radio LAN provided in the facility, the method comprising the steps of: sending an electronic coupon automatically from one radio base station arranged at one location in the facility to the radio portable terminal that has moved into a covered area of the one radio base station by using the radio LAN; and collecting the electronic coupon from the radio portable terminal at another radio base station arranged at another location in the facility by using the radio LAN, and providing a service corresponding to the electronic coupon to the user.

According to another aspect of the present invention there is provided a method for obtaining information regarding activities of a customer having a radio portable terminal in a store where a plurality of radio base stations of a radio LAN are arranged at a plurality of locations inside the facility and the plurality of radio base stations are connected to a server device through a local network, the method comprising the steps of: (a) at each radio base station, detecting the radio portable terminal that has moved into a covered area of said each radio base station by using the radio LAN, and notifying a detection of the radio portable terminal from said each radio base station to the server device through the local network; and (b) at the server device, recording a user movement information on a movement of the user according to information regarding an arranged location of said each radio base station which notified the detection of the radio portable terminal at the step (a), and managing the user movement information in relation to other information regarding purchases made by the user or services received by the user in the store.

Other features and advantages of the present invention will become apparent from the following description taken in conjunction with the accompanying drawings.

### BRIEF DESCRIPTION OF THE DRAWINGS

FIG. 1 is a schematic diagram showing an exemplary configuration of an electronic coupon service system according to the first embodiment of the present invention.

FIG. 2 is a perspective view showing an external configuration of a radio base station and its relationship with a portable terminal in the electronic coupon service system of FIG. 1.

FIG. 3 is a diagram showing an exemplary configuration of an electronic coupon used in the electronic coupon service system of FIG. 1.

FIG. 4 is a block diagram showing an exemplary internal configuration of a radio base station in the electronic coupon service system of FIG. 1.

FIG. 5 is a block diagram showing an exemplary internal configuration of a coupon server in the electronic coupon service system of FIG. 1.

FIG. 6 is a diagram showing an exemplary configuration of a user management information used in the electronic coupon service system of FIG. 1.

FIG. 7 is a block diagram showing an exemplary internal configuration of a portable terminal in the electronic coupon service system of FIG. 1.

FIG. 8 is a block diagram showing an exemplary internal configuration of a register in the electronic coupon service system of FIG. 1.

FIG. 9 is a sequence chart for an exemplary operation sequence of the electronic coupon service system of FIG. 1 at a time of sending an electronic coupon to a portable terminal.

FIGS. 10A and 10B are diagrams showing two types of electronic coupon with an electronic signature attached thereto that can be used in the electronic coupon service system of FIG. 1.

FIG. 11 is a flow chart of an exemplary procedure for producing electronic coupon in the electronic coupon service system of FIG. 1.

FIG. 12 is a diagram showing an exemplary display of a distributed electronic coupon on a portable terminal in the electronic coupon service system of FIG. 1.

FIG. 13 is a flow chart of an exemplary procedure for displaying a plurality of electronic coupons successively at a portable terminal in the electronic coupon service system of FIG. 1.

FIG. 14 is a flow chart of an exemplary procedure for automatically deleting an expired electronic coupon at a portable terminal in the electronic coupon service system of FIG. 1.

FIG. 15 is a sequence chart for an exemplary operation sequence of the electronic coupon service system of FIG. 1 at a time of collecting an electronic coupon from a portable terminal.

FIG. 16 is a sequence chart for another exemplary operation sequence of the electronic coupon service system of FIG. 1 at a time of sending an electronic coupon to a portable terminal.

FIG. 17 is a block diagram showing an exemplary configuration of an information management system according to the second embodiment of the present invention.

FIG. 18 is a schematic diagram showing an exemplary arrangement inside a store to which the information management system of FIG. 17 is applied.

FIG. 19 is a schematic diagram showing devices in a vicinity of a register area and their exemplary arrangements in the information management system of FIG. 17.

FIG. 20 is a perspective view showing an external configuration of a radio base station and its relationship with a portable terminal in the information management system of FIG. 17.

FIG. 21 is a schematic diagram showing a radio base station arranged at a doorway of a store and its relationship with a portable terminal in the information management system of FIG. 20.

FIG. 22 is a diagram showing an exemplary configuration of an electronic coupon used in the information management system of FIG. 17.

FIG. 23 is a diagram showing an exemplary configuration of a user management information used in the information management system of FIG. 17.

FIG. 24 is a sequence chart for an exemplary operation sequence of the information management system of FIG. 17 when a customer entered a doorway area of a store.

FIG. 25 is a sequence chart for an exemplary operation sequence of the information management system of FIG. 17 when a customer started to walk around inside a store for shopping.

FIG. 26 is a sequence chart for an exemplary operation sequence of the information management system of FIG. 17 at a time of collecting an electronic coupon from a portable terminal.

### DETAILED DESCRIPTION OF THE PREFERRED EMBODIMENTS

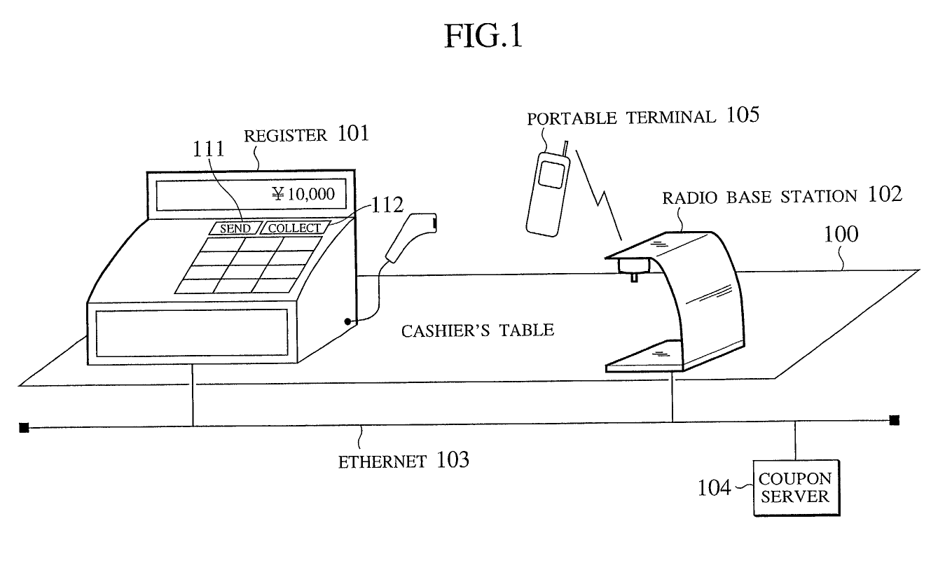

Referring now to FIG. 1 to FIG. 16, the first embodiment of an electronic coupon sending and collecting scheme and an information collecting and managing scheme according to the present invention will be described in detail.

In the following, an electronic entity (information) representing a ticket or the like that can be presented normally according to some condition to receive some discount, free gift, privileged treatment or special benefit, such as the so called discount coupon or service coupon, will be referred to as an electronic coupon. Note that the electronic coupon can be provided with various functions by attaching necessary information or by utilizing the cryptographic techniques or the like.

Also, in the following, a facility for distributing the electronic coupon and providing discount, free gift or the like upon receiving a presentation of the electronic coupon is assumed to be a store for selling various goods, a store for providing various charged services or a store for leasing various things (including all kinds of stores such as a supermarket, a convenience store or the like, a book store, a fast food store, a barber shop, a rental video store, etc., for example). Note that the following description will use terms such as a store and a customer in this context, but the present invention is also applicable to any facility which is not necessarily a store and which is not necessarily profit-making.

In this embodiment, the electronic coupon is distributed and collected electronically with respect to users (all users or those users who satisfy some condition) who utilize a given facility such as customers (all customers or those customers who satisfy some condition) who are present in the store, for example. A device to/from which the electronic coupon is to be distributed/collected by a store side system is a portable device carried around by each customer. This portable device can be an existing device for some other purposes such as portable telephone or PDA to which a function for handling the electronic coupon is added, or a device dedicated for handling the electronic coupon. In the following, all such portable devices will be collectively referred to as portable terminals.

Also, in this embodiment, the so called radio LAN will be used as a communication medium for transmitting and receiving the electronic coupon between a store side system and a portable terminal of a customer. The following description is directed to an exemplary case of using the Bluetooth which is one of the known radio LAN systems, but the present invention is also realizable by using the radio LAN system other than the Bluetooth. Note that the Bluetooth is a radio system that is expected to be installed in many portable terminals, for handling near distance wireless communications (see the URL “http://www.bluetooth.com”, for example).

Now, an exemplary system in which the electronic coupon sending/collecting is implemented in relation to a register of a retail store will be described.

FIG. 1 shows an exemplary configuration of an electronic coupon service system according to this embodiment.

This electronic coupon service system generally comprises a register 101, a radio base station 102 for exchanging the electronic coupon with a portable terminal (radio portable terminal) 105 carried around by a customer present in the store, a coupon server 104 for managing information regarding the electronic coupon, and an Ethernet 103. For example, the register 101 and the radio base station 102 are arranged on a table 100 provided at the so called register or cashier area in the store, while the coupon server 104 is arranged either in this same area or in a store manager room at a back of the store, and they are interconnected by the Ethernet 103.

Communications on the Ethernet among the register 101, the radio base station 102 and the coupon server 104 are assumed to be TCP/IP based ones as most of currently used computer communication applications (such as POS processing applications) are TCP/IP based.

On the other hand, communications between the radio base station 102 and the portable terminal 105 carried around by a customer present in the store are assumed to be Bluetooth based ones. In this way, communications between the radio base station 102 and the portable terminal 105 can be realized by local communications without utilizing the so called providers (communication carriers, Internet service providers, etc.) so that there is an advantage in that no communication cost is required for the electronic coupon exchanges.

Note that, in FIG. 1, only one set of a register and a radio base station is shown, but it is obviously also possible to connect a plurality of register and radio base station sets according to the size of the store. Moreover, instead of providing a register and a radio base station in one-to-one correspondence, it is also possible to share one or plural radio base stations among a plurality of registers. It is also possible to provide a radio base station dedicated for the coupon sending, for example.

Also, in FIG. 1, the register 101 is assumed to have an input function using bar codes, but it can be a register without a bar code input function, or a register having an input function using the other input device such as a touch panel. Also, the register 101 may be provided with the so called POS function (in which case the coupon server 104 may be used as a POS server as well), or not provided with the POS function.

FIG. 1 shows an exemplary external appearance of the register 101. The register 101 has functions of a usual register (such as a function for inputting product data or money data using bar codes or ten-keys, a function for calculating a total amount to be paid, a tax, a change, etc., a function for displaying or printing the product related information, a function for safekeeping paper cashes and coins, etc.), and in addition, in this embodiment, the register 101 is provided with a coupon send button 111 and a coupon collect button 112 for activating the electronic coupon sending processing and collecting processing via the radio base station 102.

Note that these buttons may be provided as separate buttons as described above, or as a single coupon send/collect button. Also, such buttons may be associated with the register 101 as described above, or with the radio base station 102, or with both, or with any other device. It is also possible to provide the coupon sending button on the radio base station 102 and the coupon collecting button on the register 101. Of course, they can be provided in forms of elements other than buttons, and GUI or speech input may be utilized for this purpose. In the following, an exemplary case where the coupon send button 111 and the coupon collect button 112 are separately provided will be described.

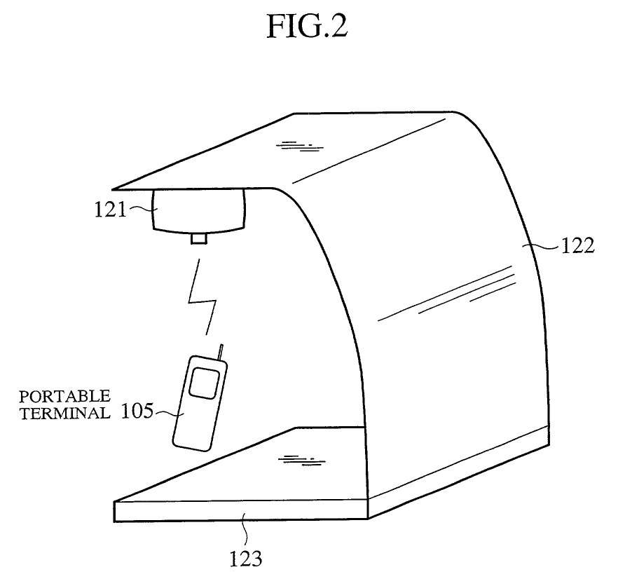

FIG. 2 shows an exemplary external appearance of the radio base station 102 and its relationship with the portable terminal 105 in this case.

In its external appearance, the radio terminal 102 comprises a radio transmission and reception unit 121, a radio shield 122, and a base 123. The radio shield 122 is provided in order to minimize interfaces of radio communications between the radio transmission and reception unit 121 and the portable terminal 105 with external radio signals, and plays a role of shielding external radio signals (especially those in frequencies used by this radio LAN).

Namely, in a store such as a convenience store or a supermarket, a microwave oven is often provided at the register area or its vicinity for the convenience of customers, but the microwave oven employs a heating mechanism using electromagnetic waves in 2.4 GHz band which is a frequency generally used in the radio LANs, so that the electromagnetic waves generated by the microwave oven can be a noise source for the radio communications between the radio base station 102 and the portable terminal 105. Also, in an environment where a plurality of the radio base stations 102 are arranged, the radio signals generated by one radio base station 102 can cause interferences with the radio signals generated by another radio base station 102. For these reasons, the radio shield 122 is provided in order to minimize the external radio disturbance factors originating from the microwave oven or the other radio base station.

Note that FIG. 2 shows an exemplary case of shielding only one side (one direction) but it is also possible to use a configuration for shielding two sides (two directions at 90° angle) or more which is more effective.

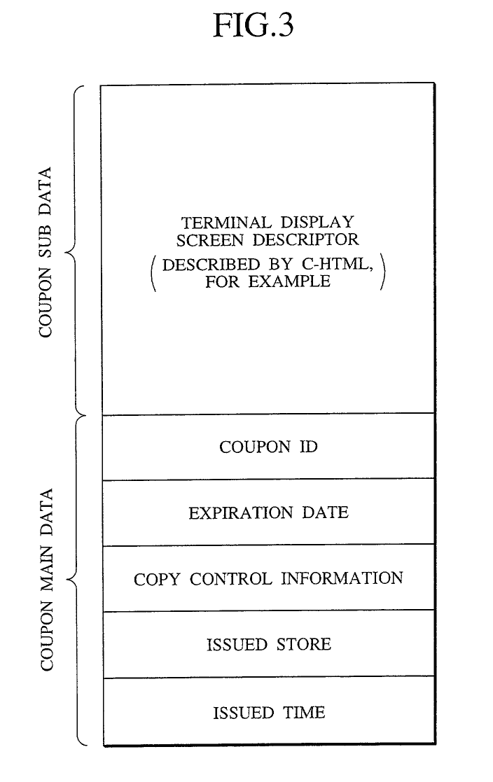

FIG. 3 shows an exemplary configuration of the electronic coupon in this embodiment.

A “terminal display screen descriptor” is a portion describing information regarding this electronic coupon, which is information for enabling a display on a display screen. Various different contents can be set for this information. For example, this information may be given by characters and/or images providing explanation regarding this electronic coupon. This information may contains advertisement information for stores or products, or speech information.

This terminal display screen descriptor should preferably be described in a language (such as a compact HTML (C-HTML)) in accordance with a format that can be displayed by the portable terminals which are targets for sending the electronic coupons from the system side.

A “coupon ID” is an identification information of this electronic coupon. Here the electronic coupon is defined as containing at least this coupon ID. The coupon server 104, the radio base station 102 and the portable terminal 105 will carry out a search necessary for the processing regarding the electronic coupon by using this coupon ID as a key.

An “expiration date” indicates a valid period of this electronic coupon. Note that the expiration date can be set by using the issued date as a reference point or by using a prescribed date as a reference point regardless of the issued date.

A “copy control information” is a control information regarding the re-distribution of this electronic coupon by copying among the portable terminals, such as an information indicating whether copying is permitted or not, for example. Namely, in the case of the conventional paper coupon, it is not a usual practice to copy the coupon and give it to someone else, but the electronic coupon is digital data which can be duplicated completely by copying. Consequently, by providing this copy control information, it becomes possible to control the re-distribution of the electronic coupon by copying among the portable terminals. For example, this electronic coupon can be copied among the portable terminals if the copy control information indicates that copying is permitted, or this electronic coupon cannot be copied among the portable terminals if the copy control information indicates that copying is not permitted.

It is also possible for this copy control information to indicate the number of times for which this electronic coupon can be re-distributed among the portable terminals. In this case, the portable terminal which acquired this electronic coupon initially can re-distribute this electronic coupon to the other portable terminals as many times as the permitted number of copies, for example. Note that, in this case, the copy control information =0 can be used as an indication that copying is not permitted.

In the case of handling the electronic coupon which can be re-distributed by copying for a limited number of times, it is preferable to provide a function for prohibiting a transfer among the portable terminals of the electronic coupon that has already been copied for the limited number of times and/or a function for prohibiting the use of the electronic coupon that is transferred among the portable terminals in violation to the permitted number of copied.

Note that it is also possible to permit copying unlimitedly by not providing the copy control information field. Similarly, it is also possible to prohibit copying by not providing the permitted number of copied field.

Also, the above example is directed to the case of copying the electronic coupon data among the portable terminals, but it is also possible to use a mechanism in which the transferred electronic coupon data is deleted at the portable terminal from which the electronic coupon is transferred when the electronic coupon data is transferred from one portable terminal to another portable terminal. In this case, a “transfer control information” indicating whether a transfer of the electronic coupon among the portable terminals as described above is permitted or not can be used instead of the above described “copy control information”, for example.

An “issued store” indicates an ID of the store which initially issued this electronic coupon.

An “issued time” indicates date and time at which this electronic coupon was initially issued.

Here, a portion excluding the terminal display screen descriptor in the data format of FIG. 3 will be referred to as a coupon main data. By setting a format of the coupon main data appropriately, it is possible to carry out various controls regarding the use of the electronic coupon or a transfer of the electronic coupon among the portable terminals.

Also, a portion other than the coupon main data will be referred to as a coupon sub data. The example shown in FIG. 3 is directed to the case where the terminal display screen descriptor is added as the coupon sub data. By setting a format of the coupon sub data appropriately, it is possible to provide various functions to the electronic coupon. Note that the coupon sub data is not an indispensable element.

It is also possible to use XML or C-HTML as a data format for the coupon main data. In this case, the coupon main data and the coupon sub data can be collectively exchanged with the coupon server 104 as a single XML document or a single C-HTML document.

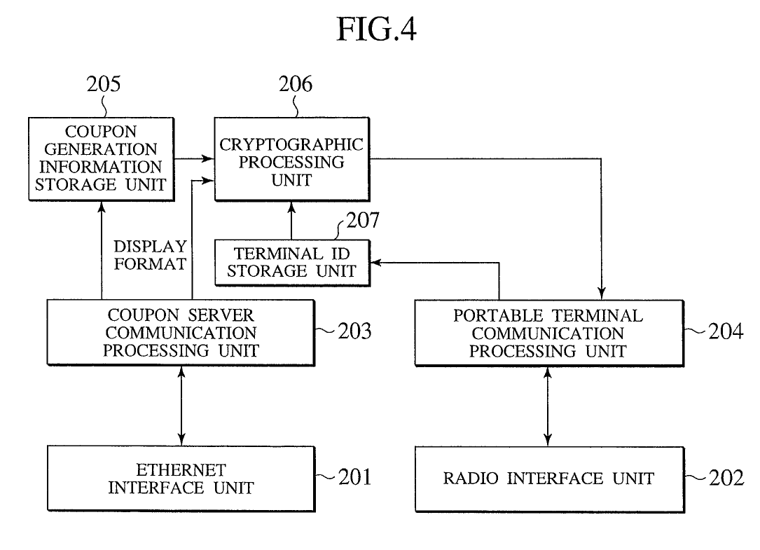

FIG. 4 shows an exemplary internal configuration of the radio base station 102.

As shown in FIG. 4, the radio base station 102 has an Ethernet interface (I/F) unit 201 for carrying out processing for communications using the Ethernet, a radio interface (I/F) unit 202 for carrying out processing for communications using the radio LAN, a coupon server communication processing unit 203 for carrying out processing for exchanges with the coupon server regarding the electronic coupon, a portable terminal communication processing unit 204 for carrying out processing for exchanges with the portable terminal regarding the electronic coupon, a coupon generation information storage unit 205 for storing information regarding the electronic coupon, a cryptographic processing unit 206 for carrying out cryptographic processing regarding the electronic coupon, and a terminal ID storage unit 207 for storing a terminal ID of the target portable terminal.

The coupon generation information stored in the coupon generation information storage unit 205 has a format comprising a set of the coupon ID and information from which the electronic coupon of this coupon ID can be generated (such as information of FIG. 3 excluding undetermined portions), for example. The coupon generation information is distributed from the coupon server 104 or the other management server in advance, for example.

Also, the cryptographic processing unit 206 has a built-in key Kp which cannot be ascertained from the external. Alternatively, the key Kp is safely acquired from the coupon server 104 into the cryptographic processing unit 206 of the radio base station 102.

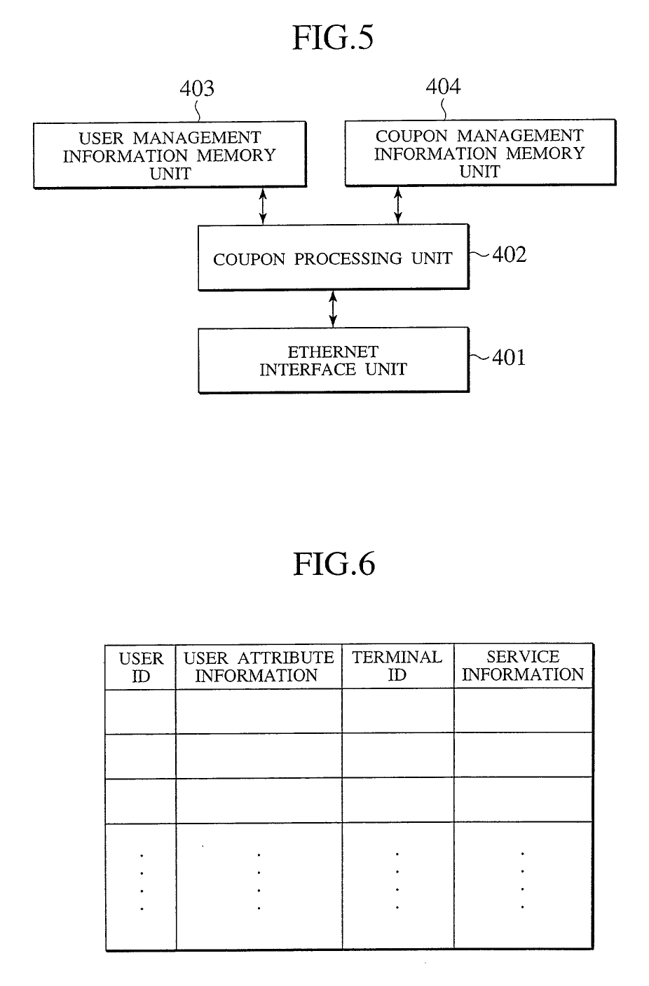

FIG. 5 shows an exemplary internal configuration of the coupon server 104.

As shown in FIG. 5, the coupon server 104 has an Ethernet interface (I/F) unit 401 for carrying out processing for communications using the Ethernet, a coupon processing unit 402 for carrying out processing regarding the electronic coupon, a user management information memory unit 403 for storing user management information, and a coupon management information memory unit 404 for storing coupon management information. Note that only a configuration related to the electronic coupon is shown and described here.

FIG. 6 shows an exemplary configuration of the user management information.

A “user ID” is an identification information of this user.

A “user attribute information” is personal information of this user such as the user's address, name, age, sex, etc.

A “terminal ID” is a terminal ID of the portable terminal registered for this user.

A “service information” is information indicating whether this user is set as a target for sending/collecting electronic coupon or not. For example, it is possible to set only the so called coupon members as targets for sending/collecting electronic coupon. It is also possible to set all the registered users as targets for sending/collecting electronic coupon in principle, and excluding only specific users (such as users who declared their intention of not utilizing the electronic coupon of this store, for example).

It is also possible to subdivide the service information such that information indicating the intended target for sending/collecting electronic coupon can be set for each electronic coupon separately or for each group of electronic coupons in a plurality of types. For example, both the electronic coupons to be sent only to the coupon members and the electronic coupons to be sent to all the registered users can be used in their proper ways.

Also, the example described here is directed to the case where sending/collecting of the electronic coupon is carried out with respect to the portable terminal under the condition that the terminal ID is registered in the user management information and the service information indicates that this user is a target for sending/collecting electronic coupon, but the service information field may be omitted in the case of carrying out sending/collecting of the electronic coupon with respect to the portable terminal under the sole condition that the terminal ID is registered in the user management information, for example.

Note that the user management information may contain various information regarding the electronic coupon, such as a log information of the electronic coupons sent to this user, a log information regarding the electronic coupons used by this user, and information for indicating or identifying the electronic coupon to be sent to this user in response to a next request.

Also, the user management information may contain various information such as a log information of the product purchases made by this user or a log information of visits to this store made by the user.

On the other hand, the coupon management information stored in the coupon management information memory unit 404 has a format comprising a set of the coupon ID and information indicating the content of the electronic coupon of this coupon ID, for example.

The content of the electronic coupon is information indicating products eligible for discount and amounts to be discounted in the case where this electronic coupon is a discount coupon at a retail store, for example.

It is also possible for this information indicating the content of the electronic coupon to contain information indicating conditions for use of this electronic coupon. For example, information indicating an upper limit on the number of products to which this electronic coupon is applicable (such as information indicating that, when plural sets of the same products are purchased, only one of them is eligible for discount, for example) in the case where this electronic coupon is a discount coupon at a retail store, for example.

Also, the coupon processing unit 402 has a cryptographic processing function using a built-in key Kp (the same key as that provided in the radio base station) that cannot be ascertained from the external.

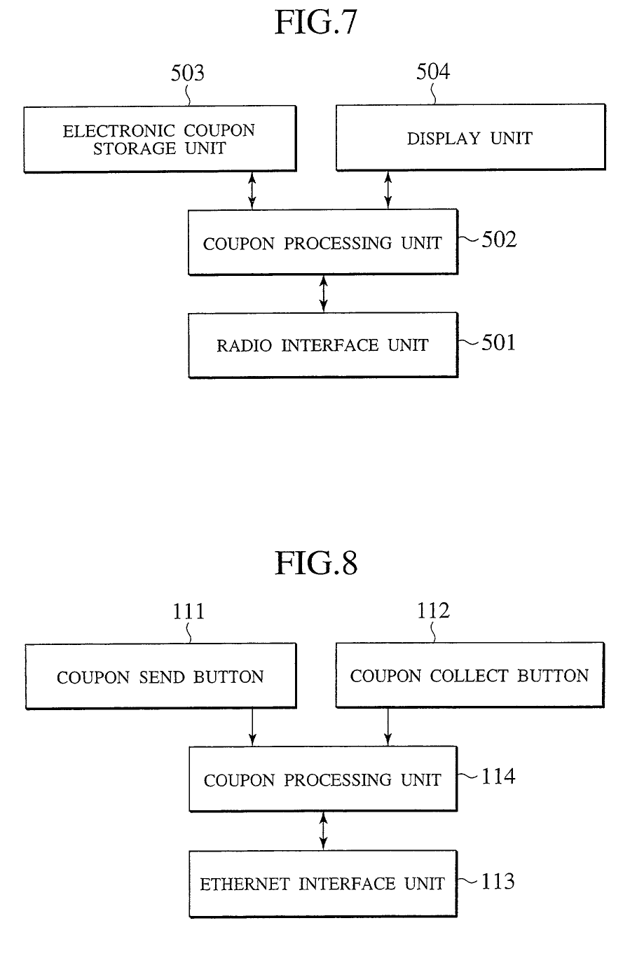

FIG. 7 shows an exemplary internal configuration of the portable terminal 105.

As shown in FIG. 7, the portable terminal 105 has a radio LAN interface (I/F) unit 501 for carrying out processing for communications using the radio LAN, a coupon processing unit 502 for carrying out processing regarding the electronic coupon, an electronic coupon storage unit 503 for storing the electronic coupons, and a display unit 504 capable of displaying information regarding the electronic coupon. Note that only a configuration related to the electronic coupon is shown and described here.

FIG. 8 shows an exemplary internal configuration of the register 101.

As shown in FIG. 8, the register 101 has an Ethernet interface (I/F) unit 113 for carrying out processing for communications using the Ethernet, a coupon processing unit 114 for carrying out processing regarding the electronic coupon, a coupon send button 111, and a coupon collect button 112. Note that only a configuration related to the electronic coupon is shown and described here.

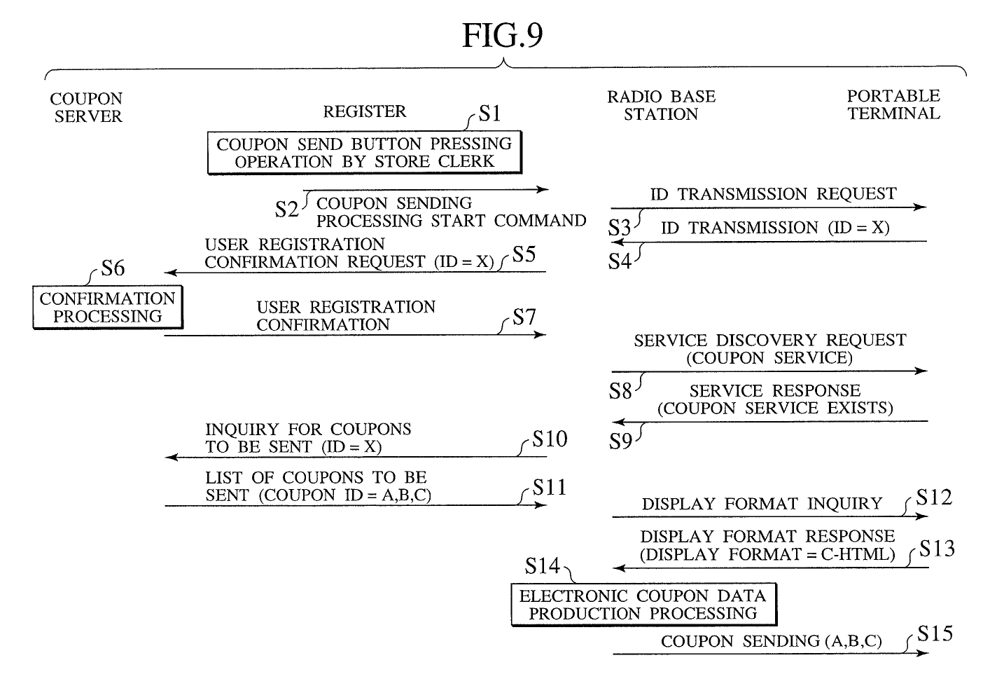

FIG. 9 shows an exemplary operation sequence at a time of sending the electronic coupon from the system side to the portable terminal in the exemplary configuration as described above.

First, in a store such as a supermarket or a convenience store, a customer gives the portable terminal 105 to a store clerk while making a request “please send a coupon into this portable terminal”, and the store clerk brings (or places) this portable terminal 105 near the radio base station 102. Alternatively, the customer himself brings (or places) this portable terminal 105 near the radio base station 102 while making the above request to the store clerk.

Next, the store clerk presses the coupon send button 111 of the register 101 (step S1). Pressing of this coupon send button 111 initiates the processing for sending the electronic coupon to the portable terminal 105.

First, when the coupon send button 111 is pressed, the register 101 transmits a message commanding a coupon sending processing start to the radio base station 102 (step S2).

The radio base station 102 for which the coupon sending processing start is commanded by the above message then makes a request for the terminal ID to the portable terminal 105 (step S3).

Here, the terminal ID is the identification information by which the portable terminal can be identified uniquely, which has different values for different portable terminals. For example, a Bluetooth address can be used as the terminal ID. Here, the terminal ID of the target portable terminal 105 is assumed to be

Upon receiving this request, the portable terminal 105 returns a message indicating that the terminal ID =x to the radio base station 102 (step S4).

Next, the radio base station 102 transmits a user registration confirmation request message for inquiring whether the portable terminal 105 that returned the terminal ID =x is registered as an electronic coupon sending target or not, to the coupon server 104 (step S5).

Upon receiving this inquiry message, the coupon server 104 carries out a confirmation processing by searching through the user management information stored therein using the terminal ID =x as a key and checking whether the terminal ID =x is registered and the service information indicating that it is set as a target for sending/collecting electronic coupon is registered or not (step S6). If the portable terminal is properly registered, a user registration confirmation message indicating that it is properly registered is notified to the radio base station 102, whereas otherwise a user registration confirmation message indicating that it is not properly registered is notified (step S7).

When the user registration confirmation message indicating that it is not properly registered is received, the radio base station 102 terminates the processing (and notifies the termination of the processing to the other device if necessary).

When the user registration confirmation message indicating that it is properly registered is received, the radio base station 102 proceeds to the processing for sending the electronic coupon to the portable terminal 105.

First, the radio base station 102 checks whether a function regarding the electronic coupon exists in the portable terminal 105 side or not. Here, this procedure is assumed to be carried out by the SDP (Service Discovery Protocol) of the Bluetooth, but the present invention is not necessarily limited to this case.

The radio base station 102 transmits a service discovery request for a service regarding the electronic coupon to the portable terminal 105 (step S8). Upon receiving this service discovery request, the portable terminal 105 returns a message indicating the existence of that service if the service regarding the electronic coupon exists in the own terminal, or a message indicating the absence of that service if that service does not exist, as a service response to the radio base station 102 (step S9).

When the service response message indicating the absence of the service is received, the radio base station 102 terminates the processing (and notifies the termination of the processing to the other device if necessary).

When the service response message indicating the existence of the service is received, the radio base station 102 transmits a message for inquiring the electronic coupons to be sent to this portable terminal 105 of the terminal ID =x, to the coupon server 104 (step

Upon receiving this inquiry message, the coupon server 104 determines the electronic coupons to be sent to the portable terminal 105 of the terminal ID =x.

Here, a method for determining the electronic coupons to be sent is not necessarily limited to any specific method, and can be carried out by a prescribed algorithm (program) provided in advance. At this point, the user management information or the coupon management information may be utilized.

As an alternative method, information regarding the electronic coupons to be sent that is obtained in advance can be set in the user management information such that the coupon server 104 that received the inquiry message searches through the user management information and determines the electronic coupons to be sent to the portable terminal 105 with the terminal ID =x.

Next, the coupon server 104 transmits a message containing information regarding the electronic coupons to be sent (such as a list of coupon IDs), to the radio base station 102 (step S11). Here, it is assumed that the electronic coupons to be sent are three types of electronic coupons with the coupon ID =A, B and C.

Upon receiving this message, the radio base station 102 produces the electronic coupons to be sent according to the notified coupon IDs (by recognizing that three types of electronic coupons with the coupon ID =A, B and C are to be sent to the portable terminal 105 with the terminal ID = x in this example).

Now, the currently available portable terminals are provided with a liquid crystal screen physically and a browser as a software so that the character screen or multimedia screen display is possible, but the display contents description format (display format) is given by any of various available formats such as HTML, C-HTML, WAP, etc. For this reason, the electronic coupons containing the terminal display screen descriptor suitable for the display contents description format requested by the portable terminal side will be produced at the radio base station 102 side here.

Namely, the radio base station 102 first transmits a display format inquiry message for inquiring which display contents description format can be displayed on a display screen of the portable terminal 105, to the portable terminal 105 (step S12).

Upon receiving this display format inquiry message, the portable terminal 105 returns a display format response message containing information that indicates the display contents description format that can be displayed at the own terminal directly (or the other display contents description format that can be converted into such a display contents description format at the own terminal), to the radio base station 102 (step S13).

The radio base station 102 adopts this notified display contents description format as the description format for the terminal display screen descriptor of the electronic coupons. Here, assuming that the notified display contents description format is C-HTML, the electronic coupons with the terminal display screen descriptor described in C-HTML will be produced.

Note that the terminal display screen descriptor in the notified display contents description format may be produced at this point, or the terminal display screen descriptors in various display contents description formats may be stored in advance.

Here, if the display contents description format notified from the portable terminal 105 is not available, the radio base station 102 terminates the processing (and notifies the termination of the processing to the other device if necessary).

When the preparation for the electronic coupon production is completed as described above, the radio base station 102 produces the electronic coupons corresponding to the notified coupon IDs, as will be described in further detail below (step S14).

Then, the radio base station 102 sends the produced electronic coupons to the portable terminal 105 through the radio LAN such as Bluetooth (step S15).

The portable terminal 105 stores the electronic coupons received from the radio base station 102 through the radio LAN such as Bluetooth.

Note that the above procedure can be modified according to needs. For example, the requests of the steps S5 and S10 can be carried out a single message, and the responses of the steps S7 and S11 can be carried out by a single message. Also, the requests of the steps S3 and S8 can be carried out by a single message, and the responses of the steps S4 and S9 can be carried out by a single message.

In the following, the production of the electronic coupon at the radio base station 102 described above will be described in further detail.

First, the application of the cryptographic processing to the electronic coupon will be described.

Namely, the electronic coupon in a state of plaintext data can easily be a target of illegal acts such as alteration (an extension of the valid period, an increase of the discount amount or rate, for example). Normally it is expected that the electronic coupon contains data that are preferably not altered so that it is preferable to prevent illegal acts by applying the cryptographic techniques to the electronic coupon.

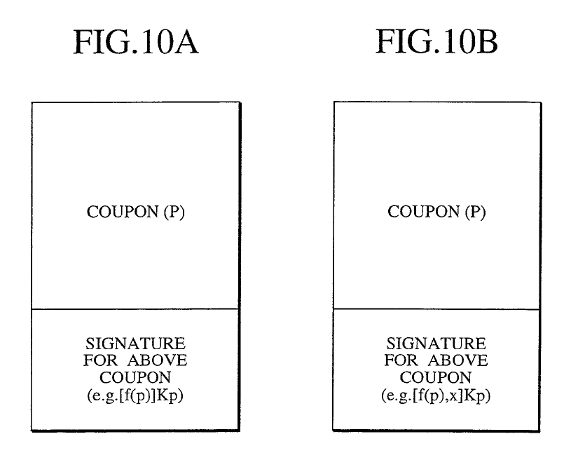

This embodiment utilizes the electronic signature as one way of realizing this. Namely, as shown in FIG. 10A, the radio base station 102 attaches an electronic signature with respect to a whole (the entire electronic coupon as shown in FIG. 3) or a part (such as the coupon main data portion of FIG. 3) of the electronic coupon data or its hash value, to the produced electronic coupon itself (the entire electronic coupon as shown in FIG. 3, for example), and then sends it to the portable terminal 105.

The electronic signature can be data (such as [p]Kp, [p′]Kp, {f(p)]Kp or [f(p′)]Kp) generated by a prescribed cryptographic algorithm using a key (denoted as Kp) that can be known only by the coupon server 104 and the radio base station 102 with respect to a whole (denoted as p) or a part (denoted as p′) of the electronic coupon itself or its hash value (denoted as f(p) or f(p′)).

Note that, in the case of FIG. 3, the terminal display screen descriptor can be excluded from a target of the electronic signature. This is because normally it suffices to prevent the alteration of the content of the electronic coupon such as the valid period, the copy control information, and the coupon ID, and if the alteration of the terminal display screen descriptor causes no problem the inclusion of the terminal display screen descriptor in the target of the electronic signature would only require extra calculation time or information transfer time at times of production and verification of the electronic signature.

Note that FIG. 10A shows the case of the electronic signature which does not use the terminal ID, but as shown in FIG. 10B, it is also possible to use the electronic signature which uses the terminal ID (x in this example) of the portable terminal that is the electronic coupon sending target in addition to the electronic coupon data. In this case, the electronic signature can be data (such as [p, x]Kp, [p′, x]Kp, [f(p, x)]Kp, [f(p′, x)]Kp,[f(p), x]Kp, or [f(p′), x]Kp) generated by a prescribed cryptographic algorithm (such as encryption) using a key Kp that can be known only by the coupon server 104 and the radio base station 102 with respect to a whole or a part of the electronic coupon itself or its hash value.

By using the electronic signature in this way, the system that carries out the processing for collecting the electronic coupon from the portable terminal can verify that the received electronic coupon is not altered, by checking that data obtained by the same procedure as used in producing the electronic signature as described above is identical to data of the electronic signature attached to the received electronic coupon.

Alternatively, data obtained by applying an inverse function (such as decryption) of the above described prescribed cryptographic algorithm by using the same key Kp with respect to the electronic signature attached to the received coupon can be compared with data obtained from the received electronic coupon according to a procedure for obtaining data in a stage immediately before the application of the above described prescribed cryptographic algorithm (that is, a whole or a part of the electronic coupon itself or its hash value (and the terminal ID)).

Now, there are various ways of using the electronic coupon. For example, there can be (1) the electronic coupon for which the re-distribution is permitted (that is, the electronic coupon is usable by another portable terminal even after the electronic coupon is transferred to that another portable terminal from the portable terminal that initially received the electronic coupon from the radio base station), and (2) the electronic coupon for which the re-distribution is prohibited (that is, the electronic coupon is usable only by the portable terminal that initially received the electronic coupon from the radio base station). As already mentioned above, the case (1) includes the case of copying the electronic coupon among the portable terminals and the case of deleting the electronic coupon from the portable terminal from which the electronic coupon is transferred.

The ways of using the electronic coupon described above can be handled by using the electronic signature of FIG. 10A in the case (1), or the electronic signature of FIG. 10B in the case (2).

In FIG. 10A, the electronic signature contains no area for confirming the terminal ID of the portable terminal, so that any portable terminal can use this electronic coupon. Namely, even when this electronic coupon is transferred from the portable terminal of the terminal ID =x to another portable terminal (of the terminal ID ≠x), this electronic coupon is still usable by that another portable terminal. Note that, in the case of the electronic coupon of FIG. 10A, a notice such as “This coupon can be copied” or “Re-distribution possible” may be displayed on a display screen of the portable terminal.

In FIG. 10B, the terminal ID =x of the portable terminal that initially received the electronic coupon is also contained in the electronic signature, so that if the system side is provided with an algorithm for verifying the electronic signature using the terminal ID of the portable terminal that can use the electronic coupon, even when this electronic coupon is entirely transferred to another portable terminal (of the terminal ID ≠x) this electronic coupon cannot be used at that another portable terminal of the terminal ID ≠x because “ID =x” is accounted in the electronic signature and therefore it is possible to realize the electronic coupon that can only be used by a specific portable terminal. Note that, in the case of the electronic coupon of FIG. 10B, a notice such as “This coupon cannot be copied” or “Only you can use this coupon” may be displayed on a display screen of the portable terminal.

Note also that, in the case of the electronic coupon for which the re-distribution is to be prohibited, the electronic coupon may be encrypted at a time of transferring it from the radio base station to the portable terminal. In this way, the improper acquisition of the electronic coupon by another portable terminal by the so called eavesdropping can also be prevented.

Note also that, both in the cases of FIG. 10A and FIG. 10B, the electronic coupon is devised such that the user cannot electronically produce the electronic coupon by himself. Namely, the electronic signature is encrypted using the key that can only be known at the system side so that only the system side can produce this electronic signature.

Also, for the sake of improving the security of the key to be used in producing the electronic signature, the different key values may be used at different stores, different times or different time zones. Else, the key may be selected randomly at a time of producing the electronic signature.

Note also that the above description is directed to the exemplary case of using the secret key cryptosystem, but it is of course also possible to use the public key cryptosystem.

It is also possible to use the electronic signature of FIG. 10A for both the cases (1) and (2), and control the prohibition of the re-distribution by some other mechanism (such as a method for making the transfer of the redistribution prohibited electronic coupon among the portable terminals impossible).

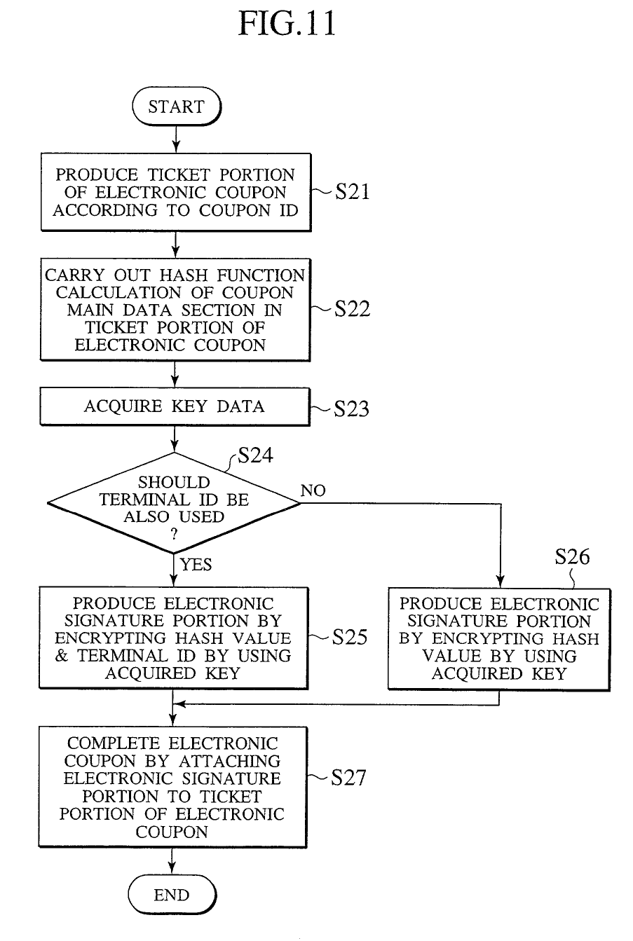

FIG. 11 shows an exemplary procedure for producing the electronic coupon at the radio base station 102.

Here, this procedure will be described for an exemplary case of using the hash value with respect to the coupon main data portion of the electronic coupon as a target of the electronic signature, using the key that varies according to the date, using the encryption as the cryptographic processing for the electronic signature, and using both the electronic coupons of FIG. 10A and FIG. 10B in their proper ways. In this case, it is assumed that the coupon server 104 has a function for searching the key from the date and the key can be delivered from the coupon server 104 to the radio base station 102 safely. It is also assumed that the coupon main data of the electronic coupon contains information for identifying the key to be used at a time of verifying the electronic signature (which is to be commonly used for the same issued time of the electronic coupons, for example).

First, a ticket portion of the electronic coupon (the entire electronic coupon as shown in FIG. 3, for example) is produced, by obtaining the coupon generation information from the coupon ID notified from the coupon server 104 and the display contents description format notified from the portable terminal 105, and acquiring or generating the other necessary information (date and time data, for example) (step S21).

Then, the hash function calculation of the coupon main data of the produced electronic coupon is carried out (step S22)

Next, the key data according to the date is acquired from the coupon server 104 securely (step S23).

Then, whether or not to use the terminal ID in the electronic signature is judged either by referring to the coupon generation information or according to a command from the coupon server 104, for example (step S24).

In the case of using the terminal ID, the electronic signature data is produced by encrypting the obtained hash value and the terminal ID by using the acquired key (step S25). On the other hand, in the case of not using the terminal ID, the electronic signature data is produced by encrypting the obtained hash value by using the acquired key (step S26).

Then, the electronic coupon is completed by attaching the produced electronic signature to the earlier produced ticket portion of the electronic coupon (step S27). In the following, a function of the portable terminal for displaying the information regarding the electronic coupon stored inside the portable terminal will be described in detail.

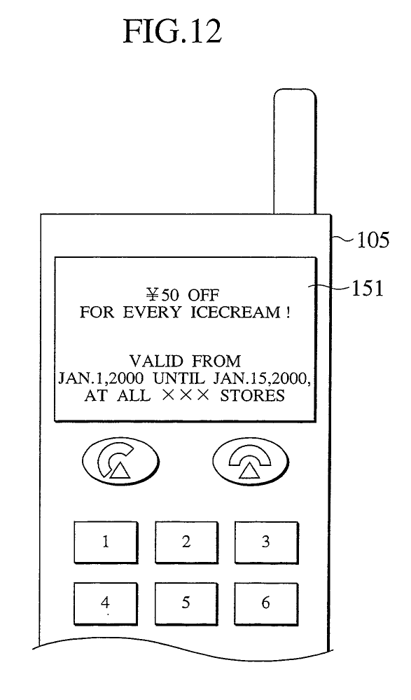

FIG. 12 shows an exemplary display of the distributed electronic coupon on a display screen 151 of the portable terminal 105, which is a display of the terminal display screen descriptor of FIG. 3, for example.

Now, the portable terminal 105 can store a plurality of electronic coupons simultaneously. These plurality of electronic coupons can be of various types, such as the electronic coupons with different IDs received at stores of the same company or at the same store or from the same radio base station, the electronic coupons received at stores of different companies or at different stores or from different radio base stations, the identical electronic coupons with different expiration dates, the identical electronic coupons with different issued times, etc.

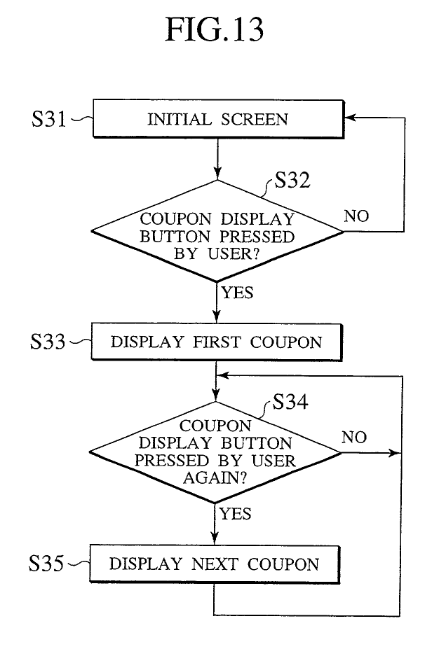

FIG. 13 shows an exemplary procedure for displaying a plurality of electronic coupons successively on the display screen of the portable terminal.

Here it is assumed that the portable terminal has a special dedicated button for commanding the coupon display. This button may not necessarily be a dedicated button, and the GUI (Graphical User Interface), or the speech recognition may be used for commanding the coupon display instead.

First, in a state of the initial screen (step S31), when the coupon display button is pressed by the user (step S32), the terminal display screen descriptor of the first electronic coupon that is selected according to prescribed criteria is displayed (step S33).

Also, when the coupon display button is pressed by the user again (step S34), the terminal display screen descriptor of the next electronic coupon that is selected according to prescribed criteria is displayed (step S35).

Thereafter, similarly, the terminal display screen descriptor of the successively selected electronic coupon is displayed whenever the coupon display button is pressed by the user (steps S34, S35).

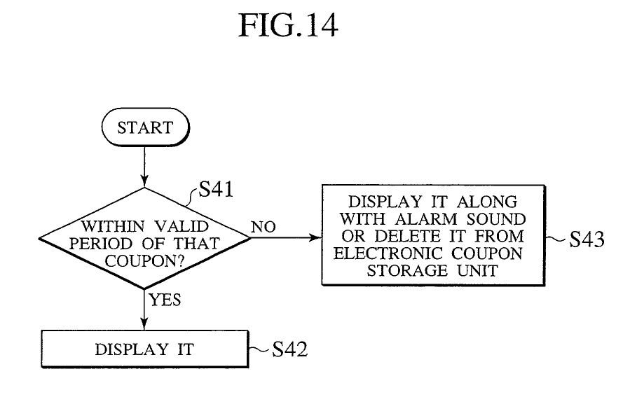

FIG. 14 shows an exemplary procedure for deleting the expired coupon at a time of the coupon display at the portable terminal.

Namely, in the procedure of FIG. 13, when the coupon display is commanded, the valid period of that electronic coupon is checked (step S41), and if the valid period has not expired yet, this electronic coupon is displayed by the ordinary method (step S42). On the other hand, if the valid period has already expired, this electronic coupon is displayed along with alarm sound and/or by a special display method (step S43).

Alternatively, at the step S43, this electronic coupon is displayed along with alarm sound and/or by a special display method, and then deleted from the electronic coupon storage unit 503 after receiving the user's confirmation input.

Alternatively, at the step S43, this electronic coupon is deleted from the electronic coupon storage unit 503 automatically, without displaying it.

Also, at the step S42, the electronic coupon with the approaching expiration date may also be displayed along with alarm sound and/or by a special display method.

Also, the electronic coupon with the expired valid period can be searched regularly (automatically) and deleted from the electronic coupon storage unit 503.

Also, when the electronic coupon is automatically deleted from the electronic coupon storage unit 503, information regarding the deleted electronic coupon may be presented to the user.

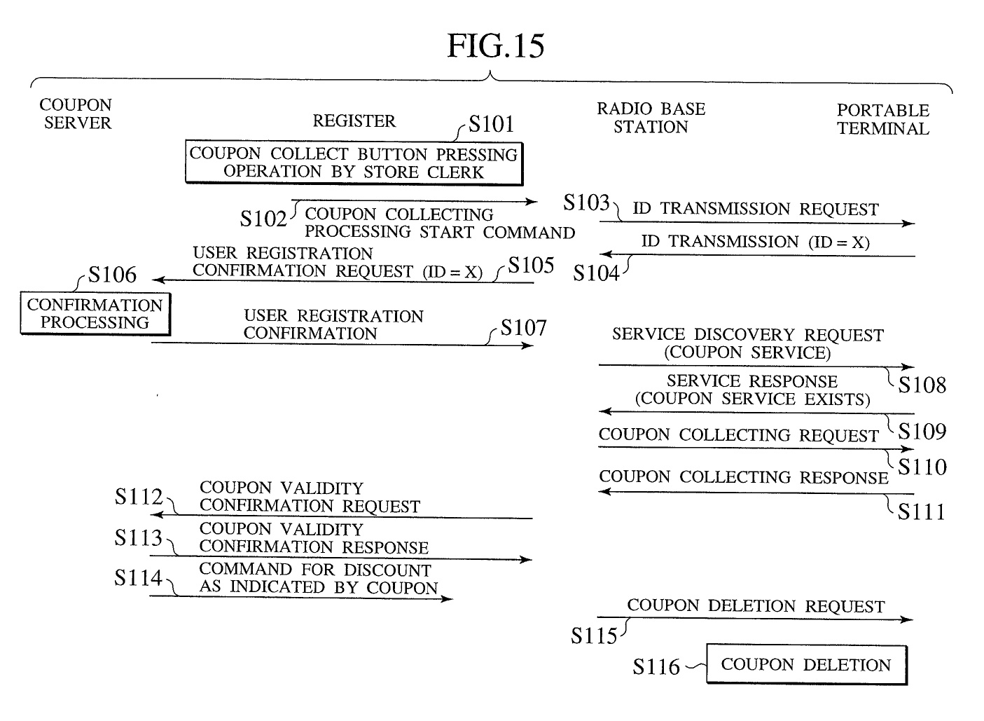

FIG. 15 shows an exemplary operation sequence at a time of collecting the electronic coupon from the portable terminal at the system side.

Here, the exemplary case where the electronic coupon is a discount coupon that can be used at a time of product purchase will be described. Also, the processing procedure of the ordinary register function at a time of product purchase will be omitted here. It should be apparent that the case of giving some free gift in exchange to the presentation of the electronic coupon can be handled similarly, except that the procedure for collecting the electronic coupon will be carried out independently from the ordinary register function in this case (in which case only the coupon collect button may be used at the register).

First, in a store such as a supermarket or a convenience store, a customer gives the portable terminal 105 to a store clerk while making a request “I want to use a coupon in this portable terminal”, and the store clerk brings (or places) this portable terminal 105 near the radio base station 102. Alternatively, the customer himself brings (or places) this portable terminal 105 near the radio base station 102 while making the above request to the store clerk.

Here, the electronic coupon whose terminal display screen descriptor is displayed on the display screen of the portable terminal may be set as a collection (utilization) target.

Namely, there can be cases where many electronic coupons are stored in the portable terminal, and setting the electronic coupon that is displayed on the display screen of the portable terminal as the collection (utilization) target can make it easier for the customer and the store clerk to confirm the electronic coupon to be collected and comprehend the content of the electronic coupon to be collected. There can also be cases where the customer intends to use the other coupon at the other store or at the other occasion, so that by collecting only the displayed electronic coupon, it is possible to prevent an accident of collecting the electronic coupon not intended by the customer (even if this electronic coupon is still within its valid period), Also, in this way it is possible to make the customer aware of the fact that he is receiving a service based on the electronic coupon, so that the advertisement effect can be expected.

In the case of setting the electronic coupon displayed on the display screen of the portable terminal as the collection (utilization) target, the customer presents the portable terminal with the desired electronic coupon displayed on its display screen.

Next, the store clerk presses the coupon collect button 112 of the register 101 (step S101). Pressing of this coupon collect button 112 initiates the processing for collecting the electronic coupon from the portable terminal 105.

First, when the coupon collect button 112 is pressed, the register 101 transmits a message commanding a coupon collecting processing start to the radio base station 102 (step S102).

The radio base station 102 for which the coupon collecting processing start is commanded by the above message then makes a request for the terminal ID to the portable terminal 105 (step S103), similarly as in the case of FIG. 9. Upon receiving this request, the portable terminal 105 returns a message indicating that the terminal ID =x to the radio base station 102 (step S104).

Next, the radio base station 102 transmits a user registration confirmation request message for inquiring whether the portable terminal 105 that returned the terminal ID =x is registered as an electronic coupon collecting target or not, to the coupon server 104 (step S105), similarly as in the case of FIG. 9.

Upon receiving this inquiry message, the coupon server 104 carries out a confirmation processing by searching through the user management information stored therein using the terminal ID =x as a key and checking whether the terminal ID =x is registered and the service information indicating that it is set as a target for sending/collecting electronic coupon is registered or not (step S106), similarly as in the case of FIG. 9. If the portable terminal is properly registered, a user registration confirmation message indicating that it is properly registered is notified to the radio base station 102, whereas otherwise a user registration confirmation message indicating that it is not properly registered is notified (step S107).

When the user registration confirmation message indicating that it is not properly registered is received, the radio base station 102 terminates the processing (and notifies the termination of the processing to the other device if necessary).

Here, it is possible to adopt a mechanism in which the customer who has a copied electronic coupon can use that electronic coupon only if the terminal ID of the portable terminal of that customer is registered at the store side. It is also possible to adopt a mechanism in which, if the terminal ID of the portable terminal of the customer is not registered at the store side, the system urges that customer to join the coupon members at the spot (and carries out the member registration at the spot).

When the user registration confirmation message indicating that it is properly registered is received, the radio base station 102 proceeds to the processing for collecting the electronic coupon from the portable terminal 105.

First, similarly as in the case of FIG. 9, the radio base station 102 transmits a service discovery request for a service regarding the electronic coupon to the portable terminal 105 (step S108). Upon receiving this service discovery request, the portable terminal 105 returns a message indicating the existence of that service if the service regarding the electronic coupon exists in the own terminal, or a message indicating the absence of that service if that service does not exist, as a service response to the radio base station 102 (step S109).

When the service response message indicating the absence of the service is received, the radio base station 102 terminates the processing (and notifies the termination of the processing to the other device if necessary).

When the service response message indicating the existence of the service is received, the radio base station 102 transmits a coupon collecting request message for requesting a collection of the electronic coupon, to the portable terminal 105 (step S110).

Upon receiving this coupon collecting request message, the portable terminal 105 transmits the entire data of the target electronic coupon, or at least data necessary in identifying that electronic coupon and data necessary in confirming the validity of that electronic coupon (the coupon main data of the ticket portion of the electronic coupon, the electronic signature, and the terminal ID of the own terminal if necessary, for example), as a response to the radio base station 102 (step S111).

Upon receiving these data, the radio base station 102 transmits a coupon validity confirmation request message containing the data necessary in identifying that electronic coupon and the data necessary in confirming the validity of that electronic coupon (the coupon main data of the ticket portion of the electronic coupon, the electronic signature, and the terminal ID, for example) to the coupon server 104 (step S112).

Here, as already mentioned above, when the terminal display screen descriptor of the ticket portion of the electronic coupon is also included in a target of the electronic signature, there is a need to transmit the content of the terminal display screen descriptor as well in order to re-calculate the electronic signature at the coupon server. In this example, it is assumed that the terminal display screen descriptor is excluded from a target of the hash function calculation.

Upon receiving these data, the coupon server 104 confirms the validity of the electronic coupon by a prescribed method as described above. Namely, the electronic signature is calculated from the coupon main data and compared with the received electronic signature. If they coincide, it implies that the electronic coupon is not altered so that the validity of the electronic coupon can be confirmed. If they do not coincide, it implies that the electronic coupon is altered so that the invalidity of the electronic coupon can be confirmed.

Note that, in the case of the electronic coupon that can be used by a specific portable terminal (of the terminal ID =x, for example) as shown in FIG. 10B, the terminal ID =x is contained in the electronic signature, so that if the terminal ID of the portable terminal from which this electronic coupon is collected is not contained in the electronic signature, it is possible to refuse the use of that electronic coupon as the electronic coupon whose validity cannot be confirmed.

When the validity of the target electronic coupon is confirmed, the coupon server 104 returns a coupon validity confirmation response to the radio base station 102 (step S113), and commands the register 101 to provide a service or a discount an amount corresponding to the electronic coupon (step S114).

Upon receiving the coupon validity confirmation response, the radio base station 102 transmits a coupon deletion request for that electronic coupon to the portable terminal 105 (step S115). Upon receiving this coupon deletion request, the portable terminal 105 deletes this electronic coupon from the electronic coupon storage unit 503 as well as from the display screen (step S116).

At the same time, the register 101 accounts for a service or a discount as notified from the coupon server 104.

When the invalidity of the target electronic coupon is confirmed by the coupon server 104, the coupon server 104 returns a response notifying this fact to the radio base station 102, and the radio base station 102 terminates the processing (and notifies the termination of the processing to the other device if necessary).

Note that the coupon sending processing may also be realized by an operation sequence to be carried out at a time of the product purchase as described in the above example.

It is also possible to use an operation sequence in which the coupon collecting processing is carried out at a time of the product purchase in relation to the purchased amount calculation, and in addition the processing for sending the electronic coupon is carried out according to the purchased product or the purchased amount.

Up to this point, the exemplary case where the electronic coupon data to be sent to the portable terminal is produced at the radio base station has been described, but it is also possible to produce the electronic coupon data at the coupon server.

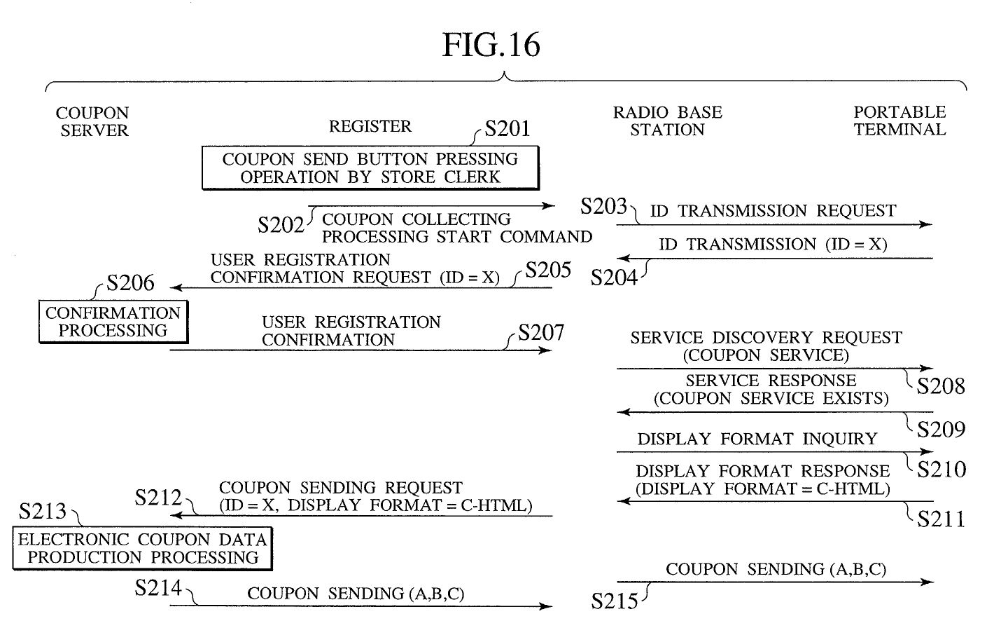

FIG. 16 shows an exemplary operation sequence at a time of sending the electronic coupon from the system side to the portable terminal in this case.

First, the procedure of the steps S201 to S209 is the same as the procedure of the steps S1 to S9 in the operation sequence of FIG. 9.

Next, in the operation sequence of FIG. 16, the inquiry and the response of the display contents description format are carried out between the radio base station 102 and the portable terminal 105. This procedure of the steps S210 and S211 is the same as the procedure of the steps S12 and S13 in the operation sequence of FIG. 9.

Next, the radio base station 102 transmits a coupon sending request message for requesting the electronic coupon data to be sent to the portable terminal of the terminal ID =x, to the coupon server 104. This procedure of the step S212 corresponds to the step S10 in the operation sequence of FIG. 9.

Next, the coupon server 104 produces the electronic coupon data (data of three types of the electronic coupons with the coupon ID =A, B and C, for example) to be sent to the portable terminal 105 of the terminal ID =x (step S213), by the method similar to the electronic coupon data production processing by the radio base station 102 at the step S14 in the operation sequence of FIG. 9.

Then, the coupon server 104 sends the produced electronic coupons to the radio base station 102 (step S214).

Then, the radio base station 102 sends the electronic coupons received from the coupon server 104 to the portable terminal 105 through the radio LAN such as Bluetooth (step S215).

The portable terminal 105 stores the electronic coupons received from the radio base station 102 through the radio LAN such as Bluetooth.

In this way, by providing the functions for producing and storing the electronic coupons to be sent to the portable terminal at the coupon server side, and notifying the terminal ID and the display format of the portable terminal from the radio base station to the coupon server, it becomes possible for the coupon server to produce the electronic coupons and sends these electronic coupons via the radio base station.

In the following, some possible variations of this embodiment will be described.

A whole or a part of the register 101, the radio base station 102 and the coupon server 104 may be provided integrally. For example, the register 101 and the radio base station 102 may be provided integrally. Also, the register 101 and the coupon server 104 may be provided integrally.

The portable terminal 105 may be a card-shaped device having a communication function, for example. It is also possible to use a configuration in which the display function is omitted from the portable terminal 105.

It is also possible to use a configuration in which the cryptographic processing function is omitted from the radio base station 102 and the coupon server 104.

It is also possible to use a configuration in which either one or both of the coupon sending/collecting processing are activated automatically by recognizing the entry of the portable terminal 105 at the radio base station 102 side automatically, rather than being activated by the pressing of the coupon send/collect buttons as described above. In the case of activating the coupon sending/collecting processing automatically, the judgement as to whether the processing to be carried out is the coupon sending processing or the coupon collecting processing can be made by various methods. For example, this judgement can be made by a method for notifying it from the portable terminal 105, or by a method for judging that it is the coupon collecting processing when the POS function is operating at the register 101 and that it is the coupon sending processing when the POS function is not operating at the register 101.

As described, according to this embodiment, it becomes possible to send and receive the electronic coupons between a radio portable terminal of a user and a system of a business enterprise without utilizing communication providers.

It is to be noted that, by utilizing the mechanism of this embodiment, the store side can collect various useful information such as “which coupon is distributed when and where”, “which coupon is collected when and where” and “whether this coupon is a copied one or not”, without requiring any manual operations for this purpose. At the same time, the store side can also collect additional information such as “what items are purchased by a customer who used this coupon” as well.

By analyzing such information, it becomes possible to analyze various trends such as an effectiveness of each distributed coupon (a relationship with a likelihood of a customer who used that coupon to visit the store again, a relationship of that coupon and items purchased by a customer, etc.), and coupon utilization patterns in relation to customer attributes (such as sex, age, and address).

In other words, the electronic coupon sending and collecting system of the first embodiment can also be utilized as the information collecting and managing system similarly as in the second embodiment described below.

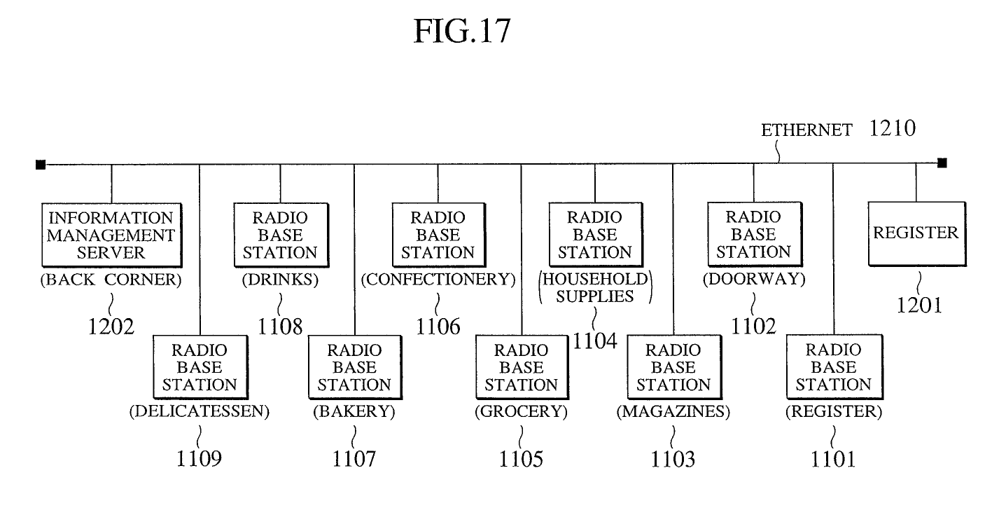

Referring now to FIG. 17 to FIG. 26, the second embodiment of an electronic coupon sending and collecting scheme and an information collecting and managing scheme according to the present invention will be described in detail.

In the following, an electronic entity (information) representing a ticket or the like that can be presented normally according to some condition to receive some discount, free gift, privileged treatment or special benefit, such as the so called discount coupon or service coupon, will be referred to as an electronic coupon.

Also, in the following, a facility for distributing the electronic coupon and providing discount, free gift or the like upon receiving a presentation of the electronic coupon is assumed to be a store for selling various goods, a store for providing various charged services or a store for leasing various things, in which customers normally walk through various areas (corners) in the store while looking through goods or the like (including many types of stores such as a supermarket, a convenience store or the like, a book store, a cafeteria type restaurant, a rental video store, etc., for example). Note that the following description will use terms such as a store and a customer in this context, but the present invention is also applicable to any facility which is not necessarily a store and which is not necessarily profit-making.

In this embodiment, the electronic coupon is distributed and collected electronically with respect to users (all users or those users who satisfy some condition) who utilize a given facility such as customers (all customers or those customers who satisfy some condition) who are present in the store, for example. A device to/from which the electronic coupon is to be distributed/collected by a store side system is a portable device carried around by each customer. This portable device can be an existing device for some other purposes such as portable telephone or PDA to which a function for handling the electronic coupon is added, or a device dedicated for handling the electronic coupon. In the following, all such portable devices will be collectively referred to as portable terminals.

Also, in this embodiment, the so called radio LAN will be used as a communication medium for transmitting and receiving the electronic coupon between a store side system and a portable terminal of a customer. The following description is directed to an exemplary case of using the Bluetooth which is one of the known radio LAN systems, but the present invention is also realizable by using the radio LAN system other than the Bluetooth. Note that the Bluetooth is a radio system that is expected to be installed in many portable terminals, for handling near distance wireless communications (see the URL “http://www.bluetooth.com”, for example).

Also, in this embodiment, a log data regarding a movement of each user inside the facility or the like is recorded by arranging radio base stations (including radio base stations to be used for sending/collecting electronic coupons) of the radio LAN at a plurality of locations inside the facility or the like and detecting a portable terminal carried around by each user in the facility or the like.

Now, an exemplary system implementing the automatic electronic coupon sending and the collection of log data regarding customer's movement inside a store in a form of a retail store will be described.

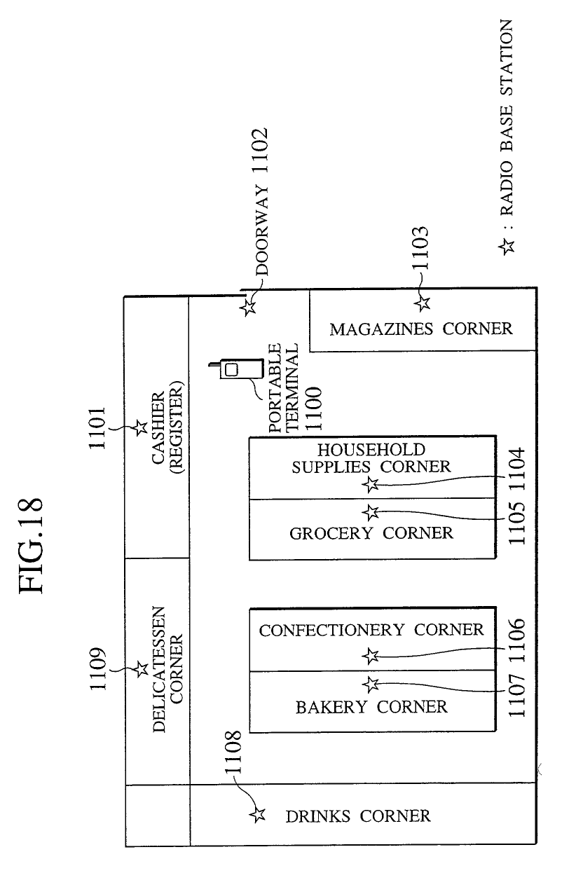

FIG. 17 shows an exemplary configuration of an information management system according to this embodiment. Also, FIG. 18 shows an exemplary arrangement of the radio base stations inside the store in this information management system, where the radio base stations are indicated by star marks.

This information management system generally comprises a register 1201, radio base stations 1101 and 1102 for carrying out exchanges regarding the electronic coupon with a portable terminal (radio portable terminal) 1100 carried around by a customer present in the store, radio base stations 1103 to 1109 arranged at various areas (corners) for detecting and comprehending a current location of the portable terminal 1100 carried around by a customer present in the store, an information management server 1202 for managing information regarding the electronic coupon and user management information, and an Ethernet 1210.

For example, the radio base station 102 is arranged at a doorway of the store, the register 1201 and the radio base station 1101 are arranged on a table provided at the so called register or cashier area in the store, the information management server 1202 is arranged either in the same area or in a store manager room at a back of the store, while the radio base stations 1103 to 1109 are arranged at respective corners in the store, and they are interconnected by the Ethernet 1210.

In this embodiment, it is assumed that the electronic coupon is sent to the portable terminal 1100 from the radio base station 1102 arranged at the doorway, and the electronic coupon is collected from the portable terminal 1100 by the radio base station 1101 arranged at the cashier (register) area. It is also assumed that the other radio base stations 1103 to 1109 do not carry out the electronic coupon sending/collecting processing.

Communications on the Ethernet among the register 201, the radio base stations 1101 to 1109 and the information management server 1202 are assumed to be TCP/IP based ones as most of currently used computer communication applications (such as POS processing applications) are TCP/IP based.

On the other hand, communications between the radio base stations 1101 to 1109 and the portable terminal 1100 carried around by a customer present in the store are assumed to be Bluetooth based ones. In this way, communications between the radio base stations 1101 to 1109 and the portable terminal 1100 can be realized by local communications without utilizing the so called providers (communication carriers, Internet service providers, etc.) so that there is an advantage in that no communication cost is required for the electronic coupon exchanges.

Note that, in FIG. 17, only one set of a register and a register associated radio base station is shown, but it is obviously also possible to connect a plurality of register and register associated radio base station sets according to the size of the store. Moreover, instead of providing a register and a register associated radio base station in one-to-one correspondence, it is also possible to share one or plural register associated radio base stations among a plurality of registers.

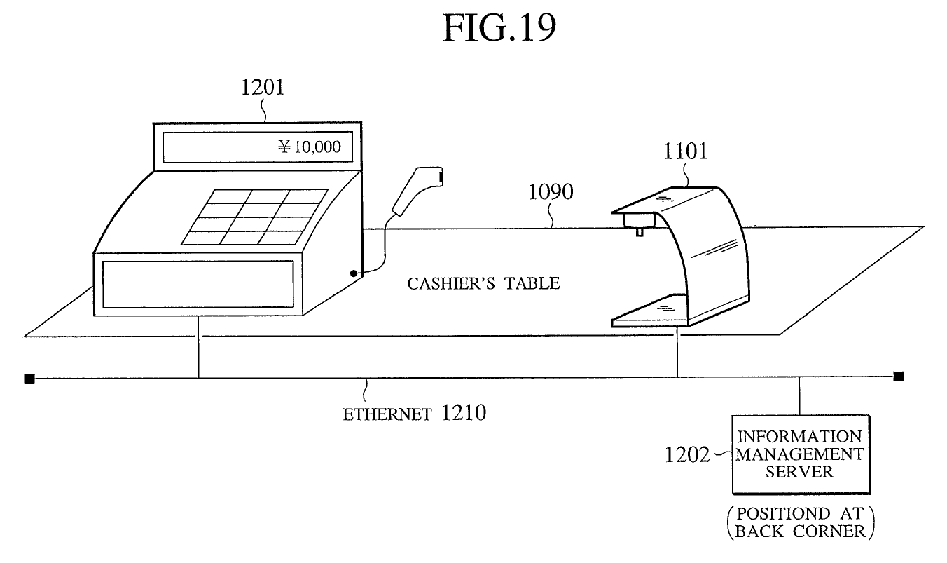

FIG. 19 shows devices provided in a vicinity of the cashier (register) area and their exemplary arrangement, where the register 1201 and the radio base station 1101 are arranged on a cashier's table 1090 such as that used in the supermarket or the convenience store, and they are connected to the Ethernet 1210.

The register 1201 has the conventionally known register functions (such as a function for inputting product data or money data using bar codes or ten-keys, a function for calculating a total amount to be paid, a tax, a change, etc., a function for displaying or printing the product related information, a function for safekeeping paper cashes and coins).

Note that, in FIG. 19, the register 1201 is assumed to have an input function using bar codes, but it can be a register without a bar code input function, or a register having an input function using the other input device such as a touch panel. Also, the register 1201 may be provided with the so called POS function (in which case the information management server 1202 may be used as a POS server as well), or not provided with the POS function.

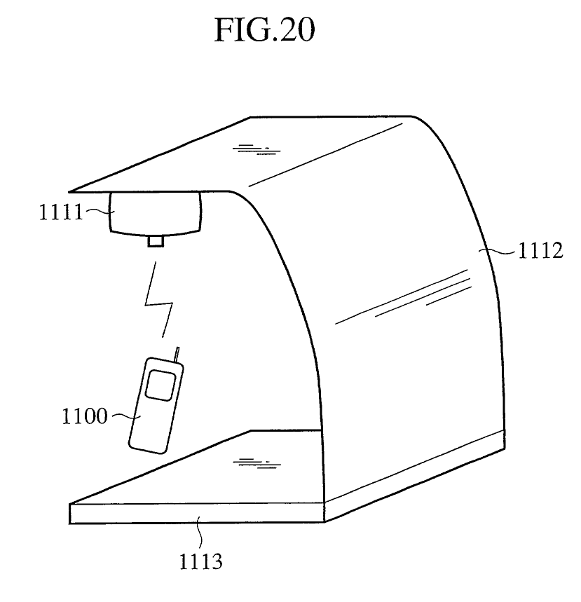

FIG. 20 shows an exemplary external appearance of the radio base station 1101 and its relationship with the portable terminal 1100.

In its external appearance, the radio terminal 1101 comprises a radio transmission and reception unit 1111, a radio shield 1112, and a base 1113. The radio shield 1112 is provided in order to minimize interfaces of radio communications between the radio transmission and reception unit 1111 and the portable terminal 1100 with external radio signals, and plays a role of shielding external radio signals (especially those in frequencies used by this radio LAN).

Namely, in a store such as a convenience store or a supermarket, a microwave oven is often provided at the register area or its vicinity for the convenience of customers, but the microwave oven employs a heating mechanism using electromagnetic waves in 2.4 GHz band which is a frequency generally used in the radio LANs, so that the electromagnetic waves generated by the microwave oven can be a noise source for the radio communications between the radio base station 1101 and the portable terminal 1100. Also, in an environment where a plurality of the radio base stations 1101 are arranged, the radio signals generated by one radio base station 1101 can cause interferences with the radio signals generated by another radio base station 1101. For these reasons, the radio shield 1112 is provided in order to minimize the external radio disturbance factors originating from the microwave oven or the other radio base station.

Note that FIG. 20 shows an exemplary case of shielding only one side (one direction) but it is also possible to use a configuration for shielding two sides (two directions at 90° angle) or more which is more effective.

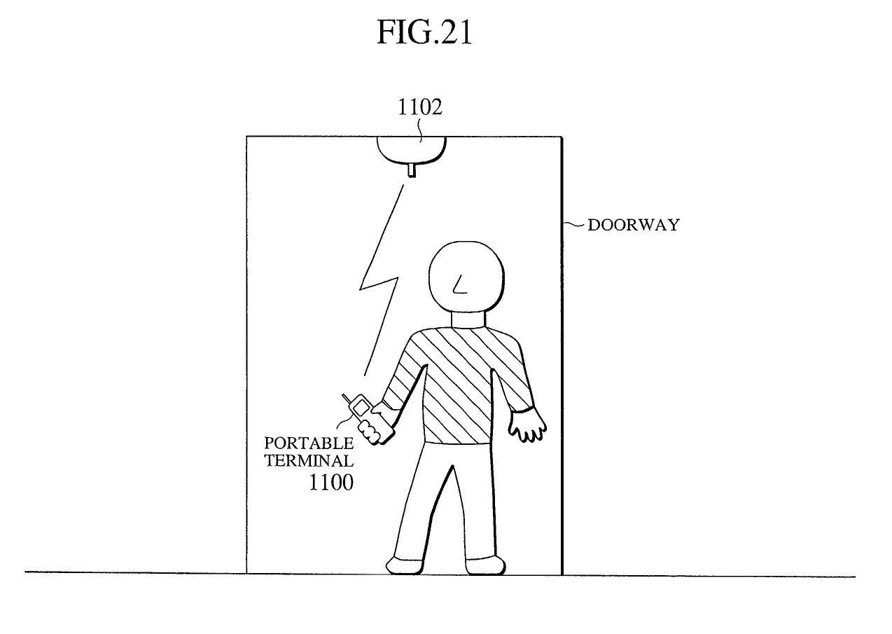

FIG. 21 shows the radio base station 1102 arranged at the doorway and its relationship with the portable terminal 1100 that communicates with it. In FIG. 21, the radio base station 1102 is provided at a ceiling side of the doorway, and carries out the electronic coupon sending with respect to the portable terminal 1100 carried around by a customer entering through the doorway. Note that FIG. 21 depicts a situation where the customer is holding the portable terminal 1100 in hand, but it should be apparent that the portable terminal 1100 may very well be in a state of being contained in a pocket or a bag carried by the customer.

Note also that the other radio base stations 1103 to 1109 can be provided at a ceiling or a shelf in the respective areas to be covered (in a manner similar to that shown in FIG. 21), and if necessary a shielding against noise sources may be provided (in a manner similar to that shown in FIG. 20).

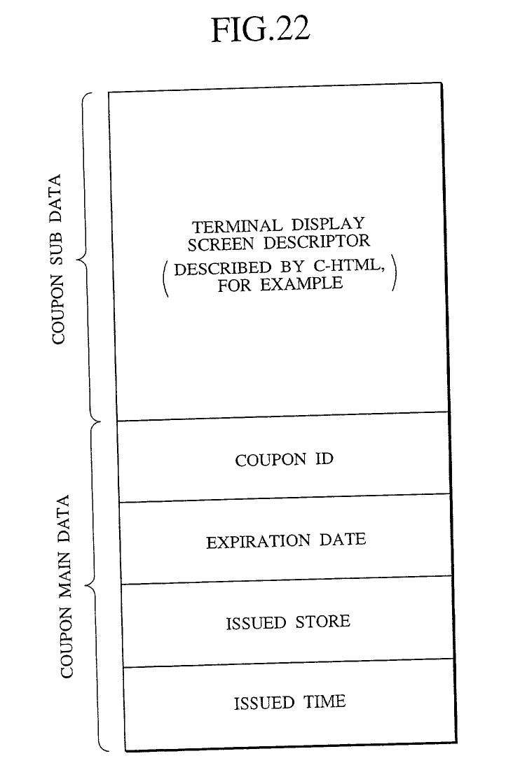

FIG. 22 shows an exemplary configuration of the electronic coupon in this embodiment.

A “terminal display screen descriptor” is a portion describing information regarding this electronic coupon, which is information for enabling a display on a display screen. Various different contents can be set for this information. For example, this information may be given by characters and/or images providing explanation regarding this electronic coupon. This information may contains advertisement information for stores or products, or speech information.

This terminal display screen descriptor should preferably be described in a language (such as a compact HTML (C-HTML)) in accordance with a format that can be displayed by the portable terminals which are targets for sending the electronic coupons from the system side.

A “coupon ID” is an identification information of this electronic coupon.

An “expiration date” indicates a valid period of this electronic coupon. Note that the expiration date can be set by using the issued date as a reference point or by using a prescribed date as a reference point regardless of the issued date.

An “issued store” indicates an ID of the store which initially issued this electronic coupon.

An “issued time” indicates date and time at which this electronic coupon was initially issued.

Here, a portion excluding the terminal display screen descriptor in the data format of FIG. 22 will be referred to as a coupon main data. By setting a format of the coupon main data appropriately, it is possible to carry out various controls regarding the use of the electronic coupon or a transfer of the electronic coupon among the portable terminals.

Also, a portion other than the coupon main data will be referred to as a coupon sub data. The example shown in FIG. 22 is directed to the case where the terminal display screen descriptor is added as the coupon sub data. By setting a format of the coupon sub data appropriately, it is possible to provide various functions to the electronic coupon. Note that the coupon sub data is not an indispensable element.

Each one of the radio base station 1101 to 1109 has an Ethernet interface unit for carrying out processing for communications using the Ethernet, and a radio interface unit for carrying out processing for communications using the radio LAN.

In addition, the radio base station 1101 has a function for collecting the electronic coupon from the portable terminal and a function for carrying out processing regarding the portable terminal location detection, and the radio base station 1102 has a function for sending the electronic coupon to the portable terminal and a function for carrying out processing regarding the portable terminal location detection.

The information management server 1202 has an Ethernet interface unit for carrying out processing for communications using the Ethernet, a user management information memory unit for storing user management information, a coupon management information memory unit for storing coupon management information, and a radio base station management information memory unit for storing radio base station management information. In addition, the information management server 1202 has a function for controlling the electronic coupon sending to the portable terminal, the electronic coupon collecting from the portable terminal and the portable terminal location detection, and a function for carrying out processing regarding each information described above.

The radio base station management information is information registering a correspondence between identifiers of the radio base stations and information indicating areas at which the radio base stations are arranged (such as doorway, register, and drinks, for example).

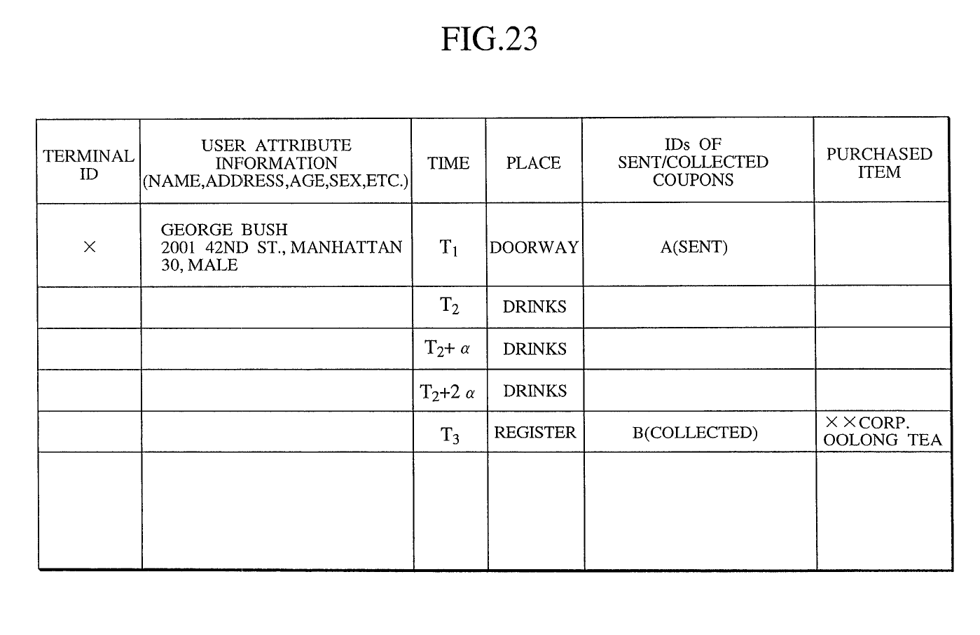

FIG. 23 shows an exemplary configuration of the user management information.

A “terminal ID” is a terminal ID of the portable terminal registered for this user.

A “user attribute information” is personal information of this user such as the user's address, name, age, sex, etc.

A “place” is information indicating an area corresponding to the radio base station which detected the portable terminal of the above described terminal ID (that is, information indicating a location of the user).

A “time” is information indicating the time at which the radio base station corresponding to the above described place detected the portable terminal of the above described terminal ID.

An “IDs of sent/collected coupons” indicates coupon IDs of the electronic coupons sent to the portable terminal of the above described terminal ID or coupon IDs of the electronic coupons collected from the portable terminal of the above described terminal ID (that is, information indicating the coupon ID and whether it is a sent coupon or a collected coupon).

A “purchased item” is information indicating items purchased by this user.

Note that the user management information may contain various other information in addition.

On the other hand, the coupon management information has a format comprising a set of the coupon ID, information indicating the content of the electronic coupon of this coupon ID, and data of the electronic coupon of this coupon ID or information from which the data can be produced (such as information of FIG. 22 excluding undetermined portions), for example.

The content of the electronic coupon is information indicating products eligible for discount and amounts to be discounted in the case where this electronic coupon is a discount coupon at a retail store, for example.

It is also possible for this information indicating the content of the electronic coupon to contain information indicating conditions for use of this electronic coupon. For example, information indicating an upper limit on the number of products to which this electronic coupon is applicable (such as information indicating that, when plural sets of the same products are purchased, only one of them is eligible for discount, for example) in the case where this electronic coupon is a discount coupon at a retail store, for example.

The portable terminal 1100 has a radio LAN interface unit for carrying out processing for communications using the radio LAN, and a function for carrying out processing regarding the electronic coupon.

The register 1201 has an Ethernet interface unit for carrying out processing for communications using the Ethernet, a function for carrying out processing regarding the electronic coupon, and a function for carrying out the usual register processing such as POS.

In the following, the operation sequence at a time of sending the electronic coupon from the system side to the portable terminal, the operation sequence in the case where the customer has moved, and the operation sequence at a time of collecting the electronic coupon from the portable terminal at the system side, in the exemplary configuration as described above will be described.

Note that the following description is directed to an exemplary case where the user management information contains information (service information) indicating whether this user (i.e., the portable terminal of this terminal ID) is set as a target for sending/collecting electronic coupon or not, and the electronic coupon sending/collecting processing is carried out when the service information indicates that this user is set as a target for sending/collecting electronic coupon. It should be apparent however that various other ways are also possible. For example, it is also possible to set the portable terminals of all the terminal IDs registered in the user management information as targets for sending/collecting electronic coupon without providing the service information, and it is also possible to determine whether or not to refer to the service information depending on the electronic coupons.

Note also that the following description is directed to an exemplary case where the recording of “time” and “place” is carried out for all the users (i.e., the portable terminals of all the terminal IDs) whose terminal IDs are registered in the user management information. It should be apparent however that it is also possible to provide some conditions on targets for recording “time” and “place”.

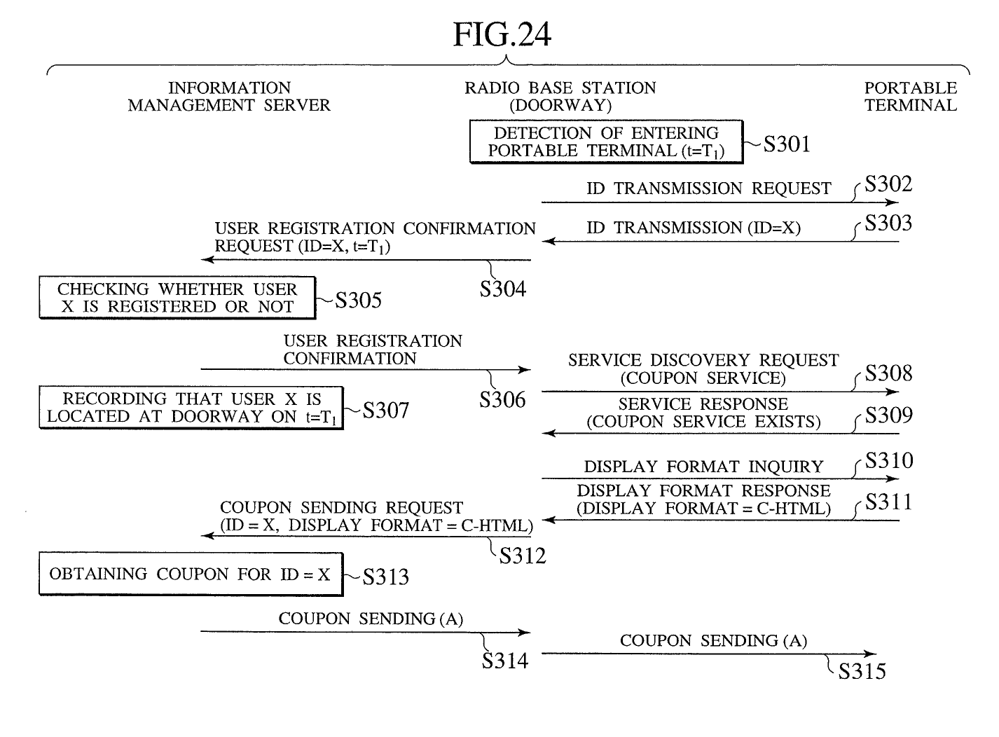

FIG. 24 shows an exemplary operation sequence at a time of sending the electronic coupon from the system side to the portable terminal.

First, suppose that a customer entered into a store such as a supermarket or a convenience store. Then, the radio base station 1102 provided at the doorway detects the entry of the portable terminal 1100 carried around by this customer (step S301). The radio base station 1102 holds the time (t =T1) of this detection. Also, the radio base station 1102 makes a request for the terminal ID to the detected portable terminal 1100 (step S302).

Here, the terminal ID is the identification information by which the portable terminal can be identified uniquely, which has different values for different portable terminals. For example, a Bluetooth address can be used as the terminal ID. Here, the terminal ID of the detected portable terminal 1100 is assumed to be “x”.

Upon receiving this request, the portable terminal 1100 returns a message indicating that the terminal ID =x to the radio base station 1102 (step S303).

Next, the radio base station 1102 at the doorway transmits a user registration confirmation request message for inquiring whether the portable terminal 1100 that returned the terminal ID =x is registered as an electronic coupon sending target or not, and for notifying the detection of the portable terminal 1100 at the time t =T1, to the information management server 1202 (step S304).

Upon receiving this inquiry message, the information management server 1202 searches through the user management information stored therein using the terminal ID =x as a key and checks whether the terminal ID =x is registered and the service information indicating that it is set as a target for sending/collecting electronic coupon is registered or not (step S305). If the portable terminal is properly registered, a user registration confirmation message indicating that it is properly registered is notified to the radio base station 1102, whereas otherwise a user registration confirmation message indicating that it is not properly registered is notified (step S306).

At the same time, the information management server 1202 records “T1” into the “time” field and “doorway” that is obtained by referring to the radio base station management information using the identifier of the radio base station 1102 (which is assumed to be contained in the message, for example) into the “place” field of the user management information as information regarding the user corresponding to this terminal ID (step S307). Here, it is assumed that times at all the radio base stations are synchronized. It is also possible to use the time on the information management server 1202 side.

Here, the “time” and the “place” are to be recorded even when the service information indicates that it is not set as a target for sending/collecting electronic coupon.

When the user registration confirmation message indicating that it is not properly registered is received, the radio base station 1102 terminates the processing (and notifies the termination of the processing to the other device if necessary).

When the user registration confirmation message indicating that it is properly registered is received, the radio base station 1102 proceeds to the processing for sending the electronic coupon to the portable terminal 1100.

First, the radio base station 1102 checks whether a function regarding the electronic coupon exists in the portable terminal 1100 side or not. Here, this procedure is assumed to be carried out by the SDP (Service Discovery Protocol) of the Bluetooth, but the present invention is not necessarily limited to this case.

The radio base station 1102 transmits a service discovery request for a service regarding the electronic coupon to the portable terminal 1100 (step S308). Upon receiving this service discovery request, the portable terminal 1100 returns a message indicating the existence of that service if the service regarding the electronic coupon exists in the own terminal, or a message indicating the absence of that service if that service does not exist, as a service response to the radio base station 1102 (step S309).

When the service response message indicating the absence of the service is received, the radio base station 102 terminates the processing (and notifies the termination of the processing to the other device if necessary).

When the service response message indicating the existence of the service is received, the radio base station 1102 transmits a display format inquiry message for inquiring which display contents description format can be displayed on a display screen of the portable terminal 1100, to the portable terminal 1100 (step S310).

Namely, the currently available portable terminals are provided with a liquid crystal screen physically and a browser as a software so that the character screen or multimedia screen display is possible, but the display contents description format (display format) is given by any of various available formats such as HTML, C-HTML, WAP, etc. For this reason, the electronic coupons containing the terminal display screen descriptor suitable for the display contents description format requested by the portable terminal side will be sent from the radio base station 1102 side here.

Upon receiving this display format inquiry message, the portable terminal 1100 returns a display format response message containing information that indicates the display contents description format that can be displayed at the own terminal directly (or the other display contents description format that can be converted into such a display contents description format at the own terminal), to the radio base station 1102 (step S311).

The radio base station 1102 adopts this notified display contents description format as the description format for the terminal display screen descriptor of the electronic coupons. Here, assuming that the notified display contents description format is C-HTML, the electronic coupons with the terminal display screen descriptor described in C-HTML will be sent.

Next, the radio base station 1102 transmits a coupon sending request message for requesting a transfer to the own station of data of the electronic coupons to be sent to this portable terminal 1100 of the terminal ID =x, and for notifying that the display contents description format is C-HTML, to the information management server 1202 (step S312).

Upon receiving this coupon sending request message, the information management server 1202 obtains the electronic coupons to be sent to the portable terminal 1100 of the terminal ID =x (step S313).

In this operation, the electronic coupons to be sent to the portable terminal 1100 of the terminal ID =x is determined first.

Here, a method for determining the electronic coupons to be sent is not necessarily limited to any specific method, and can be carried out by a prescribed algorithm (program) provided in advance. At this point, the user management information or the coupon management information may be utilized.

As an alternative method, information regarding the electronic coupons to be sent that is obtained in advance can be set in the user management information such that the information management server 1202 that received the request message searches through the user management information and determines the electronic coupons to be sent to the portable terminal 1100 with the terminal ID = x. Here, it is assumed that the electronic coupon to be sent is determined as the electronic coupon with the coupon ID =A.

Now, there is a possibility that this customer is moving back and forth around the doorway of the store, or a possibility that this customer is moving out from the store rather than entering into the store from outside. For this reason, the information management server 1202 checks whether the electronic coupon of the coupon ID =A has been sent to the portable terminal of the terminal ID =x within a prescribed period of time or not by referring to the user management information in order to prevent an error of sending the same electronic coupon to the same portable terminal.

When it is judged that all the determined electronic coupons have been sent, the information management server 1202 terminates the processing (and notifies the termination of the processing to the other device if necessary).

When it is judged that there is an electronic coupon that has not been sent, the information management server 1202 proceeds to the processing for sending the electronic coupon (in which case the electronic coupons that are judged as having been sent will not be sent).

In this operation, the corresponding electronic coupon data (or information from which it can be derived) is obtained from the coupon management information according to the coupon ID that is finally determined to be sent and the notified display contents description format. When there is an undetermined portion such as the issued time, data for that portion is produced. Also, the terminal display screen descriptior is described in the notified display contents description format here.

Note that the terminal display screen descriptor in the notified display contents description format may be produced at this point, or the terminal display screen descriptors in various display contents description formats may be stored in advance.

Also, in the case of carrying out the validity confirmation using the electronic signature at a time of the coupon collecting, the electronic signature is calculated using a whole or a part of the electronic coupon data and attached to the electronic coupon data. The terminal ID may be included in a target of the electronic signature.

Here, if the display contents description format notified from the portable terminal 1100 is not available, the information management server 1202 terminates the processing (and notifies the termination of the processing to the other device if necessary).

Next, the information management server 1202 transmits the electronic coupon (the electronic coupon of the coupon ID =A in this example), to the radio base station 1102 at the doorway (step S314).

At the same time, the information management server 1202 records “A” and “sent” into the “IDs of sent/collected coupons” field of the entry corresponding to “time” =“T1” in the user management information as information regarding the user corresponding to this terminal ID.

Then, the radio base station 1102 sends the electronic coupon received from the information management server 1202 to the portable terminal 1100 at the doorway through the radio LAN such as Bluetooth (step S315).

The portable terminal 1100 stores the electronic coupon received from the radio base station 1102 at the doorway through the radio LAN such as Bluetooth.

Note that the portable terminal 1100 has a function for displaying information (the terminal display screen descriptor, for example) added to the electronic coupon stored therein on its liquid crystal screen. For example, by describing information such as “¥30 off for juices with this coupon” or “valid from Jan. 1, 2000 until Jan. 15, 2000” in the terminal display screen descriptor, the user can display and view the service content of this electronic coupon on a liquid crystal display of the portable terminal 1100.

Now, suppose that the customer who entered the store has started to walk around inside the store for shopping.

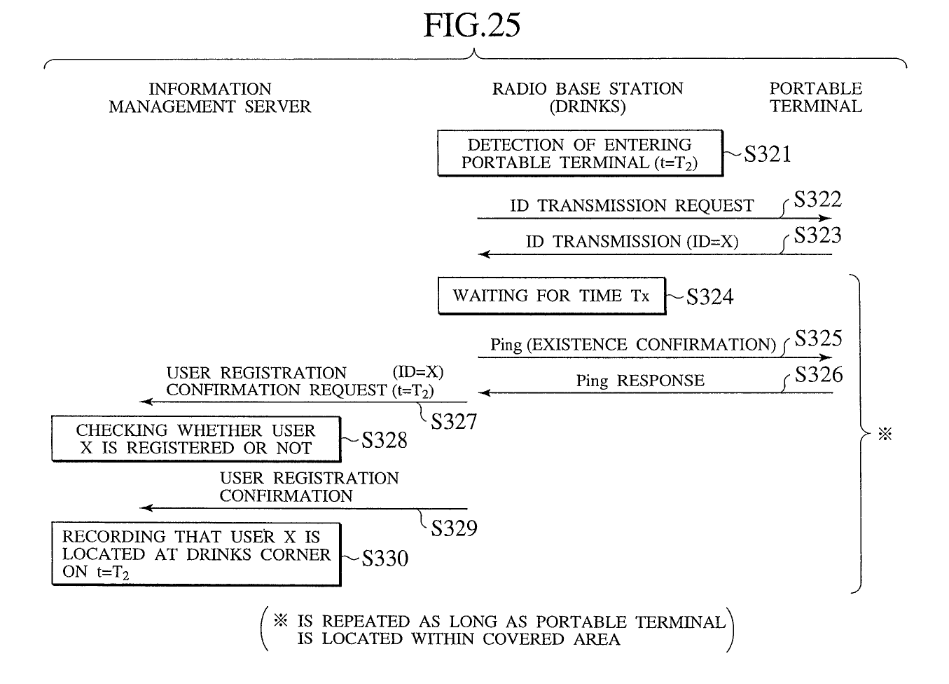

FIG. 25 shows an exemplary operation sequence in this case.

First, suppose that this customer has come to the drinks corner. Then, the radio base station 108 provided at the drinks corner detects the entry of the portable terminal 100 carried around by this customer (step S321). The radio base station 1108 holds the time (t =T2) of this detection.

Also, the radio base station 1108 makes a request for the terminal ID to the detected portable terminal 1100 (step S322).

Upon receiving this request, the portable terminal 1100 returns a message indicating that the terminal ID =x to the radio base station 1108 (step S323).

Next, the radio base station 1108 judges whether or not the portable terminal 1100 of the terminal ID =x is staying in the covered area of the own station (that is, this customer is staying at that corner) for a prescribed period of time (assumed to be Tx). This is an attempt to distinguish whether this customer is just passing by the drinks corner or this customer is engaged in some active operations such as checking some product or putting a product to be purchased into a shopping cart at this drinks corner, according to the staying time within the area covered by that radio base station.

Namely, the radio base station 1108 waits for the prescribed period of time Tx (step S324), and transmits a ping (existence confirmation) message to the portable terminal 1100 in order to check whether this portable terminal 1100 is still existing in the covered area or not (step S325). In response, the portable terminal 1100 returns a ping response (step S326).

When the ping response is not received, the radio base station 1108 terminates the processing (and notifies the termination of the processing to the other device if necessary).

When the ping response is received, the radio base station 1108 judges that this portable terminal has stayed in the covered area for over the period of time Tx, and transmits a user registration confirmation request message along with the terminal ID (=x) and the detection time (t =T2), to the information management server 1202 (step S327).

Upon receiving this user registration confirmation request message, the information management server 1202 checks whether the terminal ID =x is registered in the user management information (step S328), and returns a user registration confirmation message containing a confirmation result to the radio base station 1108 as a response (step S329).

At the same time, if the terminal ID =x is registered, the information management server 1202 records “T2” into the “time” field and “drinks” that is obtained by referring to the radio base station management information using the identifier of the radio base station 1108 (which is assumed to be contained in the message, for example) into the “place” field of the user management information as information regarding the user corresponding to this terminal ID (step S330).

The sequence of the steps S324 to S330 of FIG. 25 will be repeated at interval of the period of time Tx, as long as this customer stays at the drinks corner. Consequently, how long this customer has stayed at that corner can be analyzed later on by referring to the user management information.

Next, suppose that the customer decided the purchasing item and brought them to the cashier (register) area. Here, the purchasing item is assumed to be an oolong tea of XX corporation. It is also assumed that the electronic coupon (coupon ID =B) to be used by the customer here is applicable to this oolong tea of XX corporation.

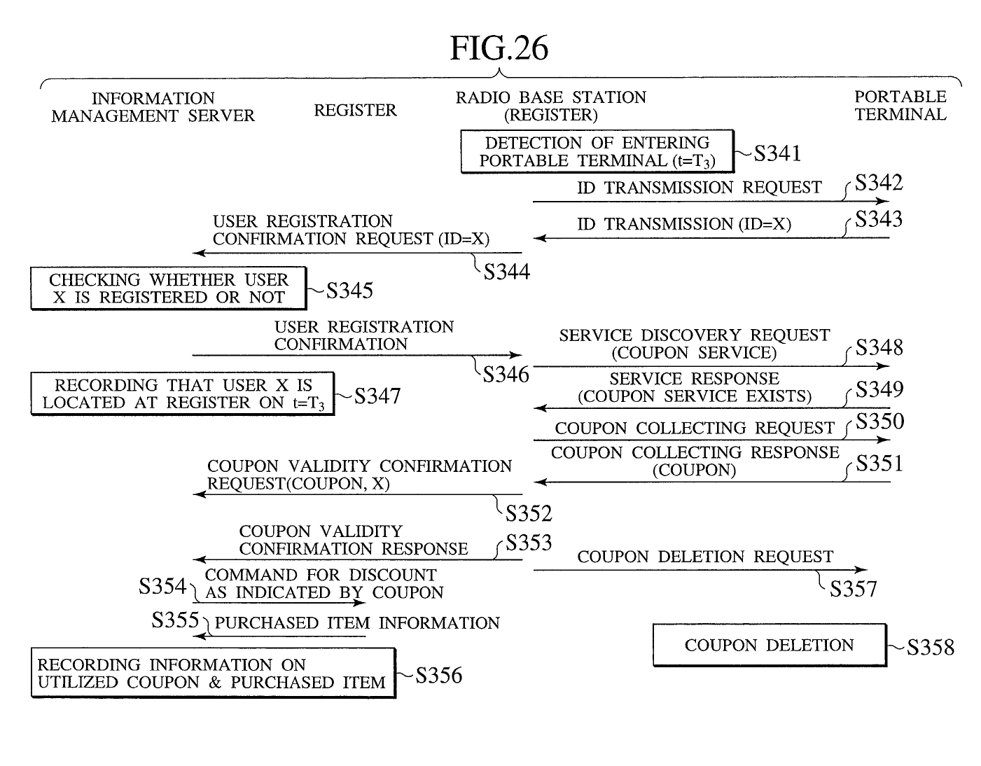

FIG. 26 shows an exemplary operation sequence at a time of collecting the electronic coupon from the portable terminal at the system side.

Here, the exemplary case where the electronic coupon is a discount coupon that can be used at a time of product purchase will be described. Also, the processing procedure of the ordinary register function at a time of product purchase will be omitted here. It should be apparent that the case of giving some free gift in exchange to the presentation of the electronic coupon can be handled similarly, except that the procedure for collecting the electronic coupon will be carried out independently from the ordinary register function in this case (in which case only the coupon collect button may be used at the register).

First, the customer gives the portable terminal 1100 to a store clerk while making a request “I want to use a coupon in this portable terminal”, and the store clerk brings (or places) this portable terminal 1100 near the radio base station 1101. Alternatively, the customer himself brings (or places) this portable terminal 1100 near the radio base station 1101 while making the above request to the store clerk.

Here, the electronic coupon whose terminal display screen descriptor is displayed on the display screen of the portable terminal may be set as a collection (utilization) target.

Namely, there can be cases where many electronic coupons are stored in the portable terminal, and setting the electronic coupon that is displayed on the display screen of the portable terminal as the collection (utilization) target can make it easier for the customer and the store clerk to confirm the electronic coupon to be collected and comprehend the content of the electronic coupon to be collected. There can also be cases where the customer intends to use the other coupon at the other store or at the other occasion, so that by collecting only the displayed electronic coupon, it is possible to prevent an accident of collecting the electronic coupon not intended by the customer (even if this electronic coupon is still within its valid period). Also, in this way, it is possible to make the customer aware of the fact that he is receiving a service based on the electronic coupon, so that the advertisement effect can be expected.

In the case of setting the electronic coupon displayed on the display screen of the portable terminal as the collection (utilization) target, the customer presents the portable terminal with the desired electronic coupon displayed on its display screen.

Then, the radio base station 1101 at the register area detects the entry of the portable terminal 1100 carried around by this customer (step S341). The radio base station 1101 holds the time (t =T3) of this detection.

Also, the radio base station 1101 makes a request for the terminal ID to the detected portable terminal 1100 (step S342).

Upon receiving this request, the portable terminal 1100 returns a message indicating that the terminal ID =x to the radio base station 1101 (step S343).

Next, the radio base station 1101 at the register area transmits a user registration confirmation request message for inquiring whether the portable terminal 1100 that returned the terminal ID =x is registered as an electronic coupon collecting target or not, and for notifying the detection of the portable terminal 1100 at the time t =T3, to the information management server 1202 (step S344).

Upon receiving this inquiry message, the information management server 1202 searches through the user management information stored therein using the terminal ID =x as a key and checks whether the terminal ID =x is registered and the service information indicating that it is set as a target for sending/collecting electronic coupon is registered or not (step S345). If the portable terminal is properly registered, a user registration confirmation message indicating that it is properly registered is notified to the radio base station 1101, whereas otherwise a user registration confirmation message indicating that it is not properly registered is notified (step S346).

At the same time, the information management server 1202 records “T3” into the “time” field and “register” that is obtained by referring to the radio base station management information using the identifier of the radio base station 1101 (which is assumed to be contained in the message, for example) into the “place” field of the user management information as information regarding the user corresponding to this terminal ID (step S347).

Here, the “time” and the “place” are to be recorded even when the service information indicates that it is not set as a target for sending/collecting electronic coupon.

It is also possible to adopt a mechanism in which, if the terminal ID of the portable terminal of the customer is not registered or if the service information indicates that it is not set as a target for sending/collecting electronic coupon, the system urges that customer to register at the spot or carries out the member registration at the spot.

When the user registration confirmation message indicating that it is not properly registered is received, the radio base station 1101 terminates the processing (and notifies the termination of the processing to the other device if necessary).

When the user registration confirmation message indicating that it is properly registered is received, the radio base station 1101 proceeds to the processing for collecting the electronic coupon from the portable terminal 1100.

First, the radio base station 1101 transmits a service discovery request for a service regarding the electronic coupon to the portable terminal 1100 (step S348). Upon receiving this service discovery request, the portable terminal 1100 returns a message indicating the existence of that service if the service regarding the electronic coupon exists in the own terminal, or a message indicating the absence of that service if that service does not exist, as a service response to the radio base station 1101 (step S349).

When the service response message indicating the absence of the service is received, the radio base station 1101 terminates the processing (and notifies the termination of the processing to the other device if necessary).

When the service response message indicating the existence of the service is received, the radio base station 1101 transmits a coupon collecting request message for requesting a collection of the electronic coupon, to the portable terminal 1100 (step S350).

Upon receiving this coupon collecting request message, the portable terminal 1100 transmits the entire data of the target electronic coupon, or at least data necessary in identifying that electronic coupon and data necessary in confirming the validity of that electronic coupon, as a response to the radio base station 1101 (step S351).

Upon receiving these data, the radio base station 1101 transmits a coupon validity confirmation request message containing the data necessary in identifying that electronic coupon and the data necessary in confirming the validity of that electronic coupon, to the information management server 1202 (step S352).

Here, in the case of using the electronic signature for the validity confirmation, the data necessary in identifying that electronic coupon and the data necessary in confirming the validity of that electronic coupon are a portion used in the electronic signature among the electronic coupon data of FIG. 22 and the electronic signature attached to that electronic coupon (the terminal ID is also necessary if the terminal ID is also used in the electronic signature), for example.

Upon receiving these data, the information management server 1202 confirms the validity of the electronic coupon by verifying the electronic signature, for example.

When the validity of the target electronic coupon is confirmed, the information management server 1202 returns a coupon validity confirmation response to the radio base station 1101 (step S353), and commands the register 1201 to provide a service or a discount an amount corresponding to the electronic coupon (step S354).

Then, the register 1201 accounts for a service or a discount as notified from the information management server 1202, and notifies information such as the utilized coupon and the purchased item (step S355). Then, the information management server 1202 records “B” and “collected” into the “IDs of sent/collected coupons” field and “oolong tea of XX corporation” into the “purchased item” field of the entry corresponding to “time” =“T3” in the user management information as information regarding the user corresponding to this terminal ID (step S356).

On the other hand, upon receiving the coupon validity confirmation response, the radio base station 1101 at the register area transmits a coupon deletion request for that electronic coupon to the portable terminal 1100 (step S357). Upon receiving this coupon deletion request, the portable terminal 1100 deletes this electronic coupon from the electronic coupon storage unit as well as from the display screen (step S358).

When the invalidity of the target electronic coupon is confirmed by the information management server 1202, the information management server 1202 returns a response notifying this fact to the radio base station 1101, and the radio base station 1101 terminates the processing (and notifies the termination of the processing to the other device if necessary). In this case, the procedure of the steps S355 and S356 is to be carried out as long as there is data to be processed (as in the case where the customer purchased the oolong tea of XX corporation without using the electronic coupon).

Note that by analyzing data stored in the user management information in this way, it becomes possible to obtain a variety of information such as manners by which the distributed electronic coupons are utilized by the customers, relationships between the customer's staying time at a specific corner and actually purchased items, a popularity of a specific corner, etc.

In the following, some possible variations of this embodiment will be described.

Up to this point, the exemplary case where the electronic coupon data to be sent to the portable terminal is produced at the information management server has been described, but it is also possible to produce the electronic coupon data at the radio base station.

Also, up to this point, the exemplary case where the time information is notified along with the terminal ID from the radio base station to the information management server has been described, but it is also possible to generate the time information at the information management server side upon receiving the notification of the terminal ID at the information management server.

Also, in the above, the exemplary case where the electronic coupon is sent to the portable terminal of the customer who passed the doorway has been described, but it is also possible to use a method in which some specific electronic coupon is sent to the portable terminal that is staying longer than a prescribed period of time at some specific corner, from the radio base station provided at that specific corner. It is also possible to use a method in which the electronic coupon is sent when the store clerk presses an operation button in response to a request for sending electronic coupon made by the customer.

Also, the register 1201 and the radio base station 1101 may be provided integrally.

The portable terminal 105 may be a card-shaped device having a communication function, for example.

It is also possible to use only a configuration for sending/collecting electronic coupon in the above described example. This case can be realized by providing only one radio base station (which should preferably be arranged at the register area for the convenience of the coupon collecting processing, as in the first embodiment described above).

It is also possible to use only a configuration for collecting a log information of the customer's movement by the detection of the portable terminal in the above described example. This case can be realized by providing at least two radio base stations (and it is not absolutely necessary to provide one radio base station at the doorway).

As described, according to this embodiment, it becomes possible to enable more detailed analysis of information regarding facility users such as customers.

Also, according to this embodiment, it becomes possible to send and receive the electronic coupons between a radio portable terminal of a user and a system of a business enterprise without utilizing communication providers.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the system of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An electronic coupon sending/collecting method for sending/collecting an electronic coupon to/from a radio portable terminal by using a radio LAN, the method comprising the steps of:
(a) requesting a notification of a terminal identifier of the radio portable terminal from a radio base station of the radio LAN to the radio portable terminal through the radio LAN;
(b) receiving the notification of the terminal identifier of the radio portable terminal from the radio portable terminal at the radio base station through the radio LAN in response to the step (a);
(c) requesting a check of whether the radio portable terminal of the terminal identifier notified by the step (b) is an electronic coupon sending/collecting target or not, from the radio base station to a server device;
(d) checking whether the radio portable terminal of the terminal identifier notified by the step (b) is the electronic coupon sending/collecting target or not at the server device, and notifying a result of the check from the server device to the radio base station in response to the step (c); and
(e) carrying out processing for sending/collecting the electronic coupon at the radio base station with respect to the radio portable terminal through the radio LAN, when the result of the check notified by the step (d) indicates that the radio portable terminal of the terminal identifier notified by the step (b) is the electronic coupon sending/collecting target.

2. An electronic coupon sending/collecting system for sending/collecting an electronic coupon to/from a radio portable terminal by using a radio LAN, the system comprising:
a radio base station of the radio LAN for carrying out communications with the radio portable terminal through the radio LAN; and
a server device for managing information regarding the electronic coupon;
wherein the radio base station has:
a first communication unit configured to send a first request message requesting a notification of a terminal identifier of the radio portable terminal to the radio portable terminal through the radio LAN, and to receive a first response message notifying the terminal identifier of the radio portable terminal from the radio portable terminal through the radio LAN in response to the first request message;
a second communication unit configured to send to the server device a second request message containing the terminal identifier notified by the first response message and requesting a check of whether the radio portable terminal of the terminal identifier notified by the first response message is an electronic coupon sending/collecting target or not, and to receive a second response message indicating a result of the check from the server device in response to the second request message; and
a processing unit configured to carry out processing for sending/collecting the electronic coupon with respect to the radio portable terminal through the radio LAN, when the result of the check notified by the second response message indicates that the radio portable terminal of the terminal identifier notified by the first response message is the electronic coupon sending/collecting target;
and the server device has:
a communication unit configured to receive the second request message from the radio base station and to send the second response message to the radio base station in response to the second request message; and
a coupon processing unit configured to check whether the radio portable terminal of the terminal identifier contained in the second request message is the electronic coupon sending/collecting target or not, and to produce the second response message indicating the result of the check.

3. The system of claim 2, wherein the second communication unit of the radio base station is also configured to send to the server device a third request message containing the terminal identifier notified by the first response message and requesting a notification of a coupon identifier of the electronic coupon to be sent to the radio portable terminal of the terminal identifier notified by the first response message, when the radio portable terminal of the terminal identifier notified by the first response message is the electronic coupon sending/collecting target, and to receive a third response message notifying the coupon identifier from the server device in response to the third request message;
the communication unit of the server device is also configured to receive the third request message from the radio base station and to send the third response message to the radio base station in response to the third request message;
the coupon processing unit of the server device is also configured to determine the coupon identifier of the electronic coupon to be sent to the radio portable terminal of the terminal identifier contained in the third request message, and to produce the third response message indicating the coupon identifier; and
the processing unit of the radio base station is also configured to carry out processing for sending the electronic coupon to the radio portable terminal, according to the coupon identifier notified by the third response message.

4. The system of claim 2, wherein the second communication unit of the radio base station is also configured to send to the server device a fourth request message containing the terminal identifier notified by the first response message and requesting a transmission of data of the electronic coupon to be sent to the radio portable terminal of the terminal identifier notified by the first response message, when the radio portable terminal of the terminal identifier notified by the first response message is the electronic coupon sending/collecting target, and to receive a fourth response message containing the data of the electronic coupon from the server device in response to the fourth request message;
the communication unit of the server device is also configured to receive the fourth request message from the radio base station and to send the fourth response message to the radio base station in response to the fourth request message;
the coupon processing unit of the server device is also configured to determine a coupon identifier of the electronic coupon to be sent to the radio portable terminal of the terminal identifier contained in the fourth request message, and to produce the fourth response message containing the data of the electronic coupon of the coupon identifier; and
the processing unit of the radio base station is also configured to carry out processing for sending the electronic coupon to the radio portable terminal, using the data of the electronic coupon contained in the fourth response message.

5. The system of the claim 2, wherein the first communication unit of the radio base station is also configured to send a fifth request message requesting a notification of a display contents description format to the radio portable terminal through the radio LAN, and to receive a fifth response message notifying the display contents description format from the radio portable terminal through the radio LAN in response to the fifth request message; and
the processing unit of the radio base station is also configured to carry out processing for sending the electronic coupon that contains display contents described by the display contents description format notified by the fifth response message, to the radio portable terminal.

6. The system of claim 5, wherein the second communication unit of the radio base station is also configured to send to the server device a sixth request message containing the terminal identifier notified by the first response message and the display contents description format notified by the fifth response message and requesting a transmission of data of the electronic coupon to be sent to the radio portable terminal of the terminal identifier notified by the first response message, when the radio portable terminal of the terminal identifier notified by the first response message is the electronic coupon sending/collecting target, and to receive a sixth response message containing the data of the electronic coupon from the server device in response to the sixth request message;
the communication unit of the server device is also configured to receive the sixth request message from the radio base station and to send the sixth response message to the radio base station in response to the sixth request message;
the coupon processing unit of the server device is also configured to determine a coupon identifier of the electronic coupon to be sent to the radio portable terminal of the terminal identifier contained in the sixth response message, and to produce the sixth response message containing the data of the electronic coupon of the coupon identifier that contains display contents described by the display contents description format contained in the sixth request message.

7. The system of claim 2, wherein the processing unit of the radio base station is also configured to carry out processing for sending the electronic coupon that contains at least a coupon identifier for uniquely identifying the electronic coupon and display contents regarding the electronic coupon.

8. The system of claim 7, wherein the processing unit of the radio base station is also configured to carry out processing for sending the electronic coupon that also contains a control information regarding a use of the electronic coupon.

9. The system of claim 7, wherein the processing unit of the radio base station is also configured to carry out processing for sending the electronic coupon that also contains an electronic signature obtained by encrypting at least a portion of data of the electronic coupon that should be protected from alteration, by using a secret key that is maintained in the radio base station and/or the server device.

10. The system of claim 7, wherein the processing unit of the radio base station is also configured to carry out processing for sending the electronic coupon that also contains an electronic signature obtained by encrypting at least a portion of data of the electronic coupon that should be protected from alteration and the terminal identifier of the radio portable terminal, by using a secret key that is maintained in the radio base station and/or the server device.

11. The system of the claim 2, wherein the first communication unit of the radio base station is also configured to send a seventh request message requesting information of the electronic coupon to be collected by the radio base station to the radio portable terminal through the radio LAN, and to receive a seventh response message containing at least first information necessary in identifying the electronic coupon to be collected and second information necessary in verifying validity of the electronic coupon to be collected, from the radio portable terminal through the radio LAN; and
the second communication unit of the radio base station is also configured to send to the server device an eighth request message containing at least the first information and the second information contained in the seventh response message and requesting a verification of the validity of the electronic coupon to be collected, and to receive an eighth response message containing a result of the verification from the server device in response to the eighth request message;
the communication unit of the server device is also configured to receive the eighth request message from the radio base station and to send the eighth response message to the radio base station in response to the eighth request message;
the coupon processing unit of the server device is also configured to verify the validity of the electronic coupon to be collected according to the first information and the second information contained in the eighth request message, and to produce the eighth response message containing the result of the verification; and
the processing unit of the radio base station is also configured to command the radio portable terminal to delete data of the electronic coupon to be collected through the radio LAN, when the result of the verification notified by the eighth response message indicates that the validity of the electronic coupon to be collected is confirmed.

12. The system of claim 11, further comprising:
a register device configured to execute a transaction for a user of the radio portable terminal;
wherein the coupon processing unit of the server device is also configured to command the register device to provide a service corresponding to the electronic coupon to be collected when the validity of the electronic coupon to be collected is confirmed.

13. The system of claim 11, wherein the second information contained in the seventh response message and the eighth request message includes an electronic signature obtained by encrypting at least a portion of data of the electronic coupon that should be protected from alteration, by using a secret key that is maintained in the server device, and data required for verifying the electronic signature; and
the coupon processing unit of the server device is also configured to verify the validity of the electronic coupon to be collected by verifying the electronic signature.

14. The system of claim 11, wherein the second information contained in the seventh response message and the eighth request message includes an electronic signature obtained by encrypting at least a portion of data of the electronic coupon that should be protected from alteration and the terminal identifier of the radio portable terminal, by using a secret key that is maintained in the server device, and data required for verifying the electronic signature; and
the coupon processing unit of the server device is also configured to verify the validity of the electronic coupon to be collected by verifying the electronic signature.

15. The system of claim 11, wherein the processing unit of the radio base station is also configured to carry out processing for collecting the electronic coupon that is currently displayed on a display screen of the radio portable terminal.

16. The system of claim 2, wherein the first communication unit of the radio terminal device is configured to send the first request message to the radio portable terminal that has moved into a covered area of the radio terminal device;
the second communication unit of the radio base station is also configured to receive data or coupon identifiers of electronic coupons to be sent to the radio portable terminal from the server device in response to the second request message;
the coupon processing unit of the server device is configured to check whether the radio portable terminal of the terminal identifier contained in the second request message is the electronic coupon sending/collecting target or not by referring to information regarding the terminal identifier of the radio portable terminal contained in the second request message, to determine the electronic coupons to be sent to the radio portable terminal that is the electronic coupon sending/collecting target, and to judge whether each electronic coupon to be sent has been sent to the radio portable terminal within a prescribed period of time by referring to information registering the terminal identifier of the radio portable terminal, coupon identifiers indicating electronic coupons that have already been sent to the radio portable terminal and information on times at which the electronic coupons that have already been sent to the radio portable terminal were sent; and
the communication unit of the server device is also configured to send the data or the coupon identifiers of only those electronic coupons to be sent that are judged as not having been sent to the radio portable terminal within the prescribed period of time, to the radio base station in response to the second request message.

17. A radio base station device for sending/collecting an electronic coupon to/from a radio portable terminal by using the radio LAN, comprising:
a first communication unit configured to send a first request message requesting a notification of a terminal identifier of the radio portable terminal to the radio portable terminal through the radio LAN, and to receive a first response message notifying the terminal identifier of the radio portable terminal from the radio portable terminal through the radio LAN in response to the first request message;
a second communication unit configured to send to a server device a second request message containing the terminal identifier notified by the first response message and requesting a check of whether the radio portable terminal of the terminal identifier notified by the first response message is an electronic coupon sending/collecting target or not, and to receive a second response message indicating a result of the check from the server device in response to the second request message; and
a processing unit configured to carry out processing for sending/collecting the electronic coupon with respect to the radio portable terminal through the radio LAN, when the result of the check notified by the second response message indicates that the radio portable terminal of the terminal identifier notified by the first response message is the electronic coupon sending/collecting target.

18. The radio base station device of claim 17, further comprising:
a radio shielding unit configured to shield radio signals from at least one direction.

19. A radio portable terminal device, comprising:
a communication unit configured to carry out communications with a radio base station of a radio LAN provided in a store;
a storage unit configured to store electronic coupons received from the radio base station through the radio LAN using the communication unit;
a display unit for displaying display contents contained in each electronic coupon stored in the storage unit on a display screen; and
a processing unit configured to carry out a processing for receiving any new electronic coupon issued by the store, a processing for using any stored electronic coupon that is usable at the store, and a processing for deleting any used electronic coupon from the storage unit, with respect to the radio base station through the radio LAN using the communication unit.

20. The device of claim 19, wherein the communication unit of the radio portable terminal device is also configured to receive a first request message requesting a notification of a terminal identifier of the radio portable terminal device from the radio base station through the radio LAN, to send a first response message notifying the terminal identifier of the radio portable terminal device to the radio base station through the radio LAN in response to the first request message, and to receive any new electronic coupon from the radio base station through the radio LAN after the first response message is sent to the radio base station; and
the processing unit of the radio portable terminal device is also configured to store any new electronic coupon received by the communication unit into the storage unit.

21. The radio portable terminal device of the claim 20, wherein the communication unit of the radio portable terminal device is also configured to receive a second request message requesting a notification of a display contents description format from the radio base station through the radio LAN, and to send a second response message notifying the display contents description format to the radio base station through the radio LAN in response to the second request message, and to receive the electronic coupon that contains display contents described by the display contents description format notified by the second response message from the radio base station through the radio LAN; and
the processing unit of the radio portable terminal device is also configured to control the display unit to display any new electronic coupon received by the communication unit on the display screen.

22. The device of claim 19, wherein the processing unit of the radio portable terminal device is also configured to carry out a processing for using any stored electronic coupon that is currently displayed on the display screen by the display unit, and to delete data of any stored electronic coupon that is currently displayed on the display screen from the storage unit, upon receiving a third request message commanding a deletion of the data of a used electronic coupon.

23. A method for collecting and managing information on a movement of a user having a radio portable terminal in a facility where a plurality of radio base stations of a radio LAN are arranged at a plurality of locations inside the facility and the plurality of radio base stations are connected to a server device through a local network, the method comprising the steps of:
(a) requesting a notification of a terminal identifier of the radio portable terminal that has moved into a covered area of each radio base station, from said each radio base station to the radio portable terminal through the radio LAN, and receiving the notification of the terminal identifier from the radio portable terminal at said each radio base station through the radio LAN;
(b) notifying the terminal identifier notified at the step (a) from said each radio base station to the server device through the local network; and
(c) recording and managing a management information containing the terminal identifier notified at the step (b) and information regarding an arranged location of said each radio base station which notified the terminal identifier at the step (b), at the server device.

24. A system for collecting and managing information on a movement of a user having a radio portable terminal in a facility, the system comprising:
a plurality of radio base stations of a radio LAN that are arranged at a plurality of locations inside the facility; and
a server device connected to the plurality of radio base stations through a local network;
wherein each radio base station has:
a first communication unit configured to request a notification of a terminal identifier of the radio portable terminal that has moved into a covered area of said each radio base station to the radio portable terminal through the radio LAN, and to receive the notification of the terminal identifier from the radio portable terminal through the radio LAN; and
a second communication unit configured to notify the terminal identifier received by the first communication unit, to the server device through the local network;
and the server device has:
a communication unit configured to receive a notification of the terminal identifier from each radio base station through the local network; and
a management unit configured to record and manage a management information containing the terminal identifier received by the communication unit and a location information regarding an arranged location of said each radio base station that notified the terminal identifier received by the communication unit.

25. The system of claim 24, wherein each radio base station also has:
a processing unit configured to make a judgement as to whether the radio portable terminal that has moved into the covered area of said each radio base station is staying in the covered area of said each radio base station for over a prescribed period of time or not;
wherein the second communication unit of each radio base station is configured to notify the terminal identifier received by the first communication unit only when the processing unit judges that the radio portable terminal that has moved into the covered area of said each radio base station is staying in the covered area of said each radio base station for over a prescribed period of time.

26. The system of claim 25, wherein the processing unit of each radio base station is configured to make the judgement repeatedly, and the second communication unit of each radio base station is configured to notify the terminal identifier received by the first communication unit whenever the processing unit judges that the radio portable terminal that has moved into the covered area of said each radio base station is staying in the covered area of said each radio base station for over a prescribed period of time.

27. The system of claim 24, wherein the management unit of the server device is configured to record and manage the management information that also contains a time information indicating a time at which the radio portable terminal is detected in the covered area of said each radio base station.

28. The system of claim 24, wherein:
one radio base station among the plurality of radio base stations has:
the first communication unit that is configured to send a first request message requesting the notification of the terminal identifier of the radio portable terminal to the radio portable terminal through the radio LAN, and to receive a first response message notifying the terminal identifier of the radio portable terminal from the radio portable terminal through the radio LAN in response to the first request message;
the second communication unit that is also configured to send to the server device a second request message containing the terminal identifier notified by the first response message and requesting a check of whether the radio portable terminal of the terminal identifier notified by the first response message is an electronic coupon sending target or not, and to receive a second response message indicating a result of the check from the server device in response to the second request message; and
a processing unit configured to carry out processing for sending the electronic coupon with respect to the radio portable terminal through the radio LAN, when the result of the check notified by the second response message indicates that the radio portable terminal of the terminal identifier notified by the first response message is the electronic coupon sending target;
and the server device has:
the communication unit that is also configured to receive the second request message from the one radio base station and to send the second response message to the one radio base station in response to the second request message; and
a coupon processing unit configured to check whether the radio portable terminal of the terminal identifier contained in the second request message is the electronic coupon sending target or not, and to produce the second response message indicating the result of the check.

29. The system of claim 28, wherein the coupon processing unit of the server device is configured to check whether the radio portable terminal of the terminal identifier contained in the second request message is the electronic coupon sending target or not by referring to information regarding the terminal identifier of the radio portable terminal of the terminal identifier contained in the second request message, and to determine the electronic coupons to be sent to the radio portable terminal only when the radio portable terminal of the terminal identifier contained in the second request message is the electronic coupon sending target.

30. The system of claim 28, wherein the coupon processing unit of the server device is also configured to judge whether each electronic coupon to be sent has been sent to the radio portable terminal within a prescribed period of time by referring to information registering the terminal identifier of the radio portable terminal, coupon identifiers indicating electronic coupons that have already been sent to the radio portable terminal and information on times at which the electronic coupons that have already been sent to the radio portable terminal were sent; and
the communication unit of the server device is also configured to send the data or the coupon identifiers of only those electronic coupons to be sent that are judged as not having been sent to the radio portable terminal within the prescribed period of time, to the radio base station in response to the second request message.

31. The system of claim 28, wherein said one radio base station is located at a doorway of the facility.

32. The system of claim 28, wherein the facility is a store, the plurality of radio base stations are arranged at a plurality of corners provided inside the store, and the location information regarding the arranged location of said each radio base station indicates a corner at which said each radio base station is arranged.

33. The system of claim 32, wherein the management information contains at least the terminal identifier of the radio portable terminal of the user, the location information indicating a corner at which said each radio base station is arranged, a time information indicating a time at which the radio portable terminal is detected in the covered area of said each radio base station, and a product information regarding products purchased by the user that is entered from a register device for executing a transaction for the user of the radio portable terminal.

34. The system of claim 33, wherein at least one radio base station among the plurality of the radio base stations is arranged in a vicinity of the register device.

35. The system of claim 28, wherein another radio base station among the plurality of radio base stations has:
the first communication unit that is configured to send a first request message requesting the notification of the terminal identifier of the radio portable terminal to the radio portable terminal through the radio LAN, and to receive a first response message notifying the terminal identifier of the radio portable terminal from the radio portable terminal through the radio LAN in response to the first request message;
the second communication unit that is also configured to send to the server device a second request message containing the terminal identifier notified by the first response message and requesting a check of whether the radio portable terminal of the terminal identifier notified by the first response message is an electronic coupon collecting target or not, and to receive a second response message indicating a result of the check from the server device in response to the second request message; and
a processing unit configured to carry out processing for collecting the electronic coupon with respect to the radio portable terminal through the radio LAN, when the result of the check notified by the second response message indicates that the radio portable terminal of the terminal identifier notified by the first response message is the electronic coupon collecting target;
and the server device has:
the communication unit that is also configured to receive the second request message from the another radio base station and to send the second response message to the another radio base station in response to the second request message; and
a coupon processing unit configured to check whether the radio portable terminal of the terminal identifier contained in the second request message is the electronic coupon collecting target or not, and to produce the second response message indicating the result of the check, and to command a register device for executing a transaction for the user of the radio portable terminal to provide a service corresponding to the electronic coupon to be collected when the validity of the electronic coupon to be collected is confirmed.

36. The system of claim 35, wherein the management information also contains information regarding electronic coupons sent to a radio portable terminal of each terminal identifier and information regarding electronic coupons collected from a radio portable terminal of each terminal identifier.

37. A method for providing an electronic coupon service in a facility to a user of the facility who has a radio portable terminal by using a radio LAN provided in the facility, the method comprising the steps of:
sending an electronic coupon from one radio base station provided in the facility to the radio portable terminal by using the radio LAN, in response to a request for acquiring coupon made by the user; and
collecting the electronic coupon from the radio portable terminal at the one radio base station or another radio base station provided in the facility by using the radio LAN, and providing a service corresponding to the electronic coupon to the user, in response to a request for using acquired coupon made by the user.

38. A method for providing an electronic coupon service in a facility to a user of the facility who has a radio portable terminal by using a radio LAN provided in the facility, the method comprising the steps of:
sending an electronic coupon automatically from one radio base station arranged at one location in the facility to the radio portable terminal that has moved into a covered area of the one radio base station by using the radio LAN; and
collecting the electronic coupon from the radio portable terminal at another radio base station arranged at another location in the facility by using the radio LAN, and providing a service corresponding to the electronic coupon to the user.

39. A method for obtaining information regarding activities of a customer having a radio portable terminal in a store where a plurality of radio base stations of a radio LAN are arranged at a plurality of locations inside the facility and the plurality of radio base stations are connected to a server device through a local network, the method comprising the steps of:
(a) at each radio base station, detecting the radio portable terminal that has moved into a covered area of said each radio base station by using the radio LAN, and notifying a detection of the radio portable terminal from said each radio base station to the server device through the local network; and
(b) at the server device, recording a user movement information on a movement of the user according to information regarding an arranged location of said each radio base station which notified the detection of the radio portable terminal at the step (a), and managing the user movement information in relation to other information regarding purchases made by the user or services received by the user in the store.
